(19) United States
(12) Patent Application Publication
(10) Pub. No.: US 2016/0134737 A1
(43) Pub. Date: May 12, 2016

(54) SYSTEM HAVING A MINIATURE PORTABLE ELECTRONIC DEVICE FOR COMMAND AND CONTROL OF A PLURALITY OF WIRELESS DEVICES

(71) Applicant: Ravi PULLETIKURTY, Fremont, CA (US)

(72) Inventor: Ravi Kumar Pulletikurty, Fremont, CA (US)

(21) Appl. No.: 14/953,299

(22) PCT Filed: May 27, 2014
(86) PCT No.: PCT/US14/39554

§ 371 Date: Nov. 28, 2015

Related U.S. Application Data
(60) Provisional application No. 61/828,095, filed on May 28, 2013.

(51) Int. Cl. H04M 1/725; G06F 3/0485; H04W 4/00; G06F 3/0484; G06F 3/02; G06F 3/0482; G06F 3/0488

(52) U.S. Cl. CPC H04M 1/7253; G06F 3/0482; G06F 3/0485; G06F 3/04883; G06F 3/04847; G06F 3/04842; G06F 3/0227; H04W 4/001; H04M 1/72525

(57) ABSTRACT

Disclosed system comprising a miniature portable electronic device for interacting with a plurality of electronic devices including at least one smart device, at least one wireless electronic device and at least one remote web server connected to the miniature portable electronic device over a wireless communication network. The system allows a user of the miniature portable electronic device to have partial and/or full control of a variety of electronic devices connected to the miniature portable electronic device over the wireless network. The miniature portable electronic device delivers functionality via its mini-apps to the user and optionally connects to the smart devices, the wireless devices and Internet. The miniature device is encased into wearable devices having a variety of shapes and form factors such as a finger ring, pendant to a neck chain, keychain, etc.

This application claims priority to the PCT Application no. PCT/US14/39554, filed on Apr. 27, 2014, entitled “System having a miniature portable electronic device for command and control of a plurality of wireless devices” which further claims the benefit of U.S. provisional application U.S. 61/828,095 filed on May 28, 2013. The specification of the above referenced patent application is incorporated herein by reference in its entirety.

### BACKGROUND

The present invention relates to a system comprising electronic devices and in particular to a miniature portable electronic device for command and control of a plurality of electronic devices over a wireless communication network.

With the advancement of technology and production of electronic products more portable, more intelligent, wearable and miniature electronic devices in all aspects of life and other people's work have broad application prospects. In recent years, with the rapid development of electronic technology, more and more advanced functions are being provided in a portable and wearable devices. For example, wearable devices are now provided with a Bluetooth function supporting Bluetooth communication. The wearable device supporting the Bluetooth function allows for remotely controlling call execution functions as well as listening to music by a Bluetooth headset.

A conventional wearable device comes preloaded with a plurality of applications and a Bluetooth connection is established between the Bluetooth device and the wearable device. The Bluetooth device may be playing media data and its functionalities such as ON/OFF can be controlled by the wearable device from a small distance apart. The users cannot upgrade some of the existing wearable device manually. However for configuring the plurality of preloaded Apps of the wearable device and for configuring its functionality, the device is still need to be connected to the Smartphone or a computer having Internet connectivity for configuring the Apps. Moreover, a plurality of functionalities of the existing wearable device cannot be controlled over a wireless network in real time by using existing devices. In addition, the exiting devices cannot be used for making and receiving at least one call by automatically connecting to the smart devices such as a smartphone. However, the exiting wearable devices have at least the following problems such as difficulty in man-machine interaction, minimal integration with a smartphone or other electronic device. Using existing wearable devices only a function or a small group of functions of the device connected using Bluetooth connectivity can be controlled. The smaller size of the smart watches or wearable devices makes it even more difficult to implement, and inconvenient operation, voice recognition rate of voice control and difficult to guarantee, high power consumption, not smart ideal control method and the user experience is poor.

Thus, there exists a need for an improved system and device that provides smart control over a variety of electronic devices. Moreover, the needed system would provide convenient operation and would be operated by each individual easily. In addition, the needed system would be easily operated by anyone without the need to employ any complex methods and learning and without the need to possess any advanced technical knowledge. The needed system would allow the users to have partial and/or full control of variety of electronic devices connected over a wireless network. Further, the needed system would be cost effective, simple, user-friendly, can easily be set up, and can be used by the user while he/she is performing different activities. The system can be universally employable and would be available in a variety of types and form factors. In addition, the needed system and device would possibly be employed by anyone according to their personal preferences such as color, design, ergonomic options, etc. In addition the needed system would allow the users to make and receive calls. The present invention addresses such a need.

### SUMMARY

The present invention is a system having a miniature portable electronic device for interacting with a plurality of electronic devices including at least one smart device, at least one wireless electronic device and at least one remote web server connected to the miniature portable electronic device over a wireless communication network. The miniature portable electronic device having a plurality of hardware components capable of being operated by a plurality of instructions of an operating program installed in the miniature portable electronic device. The plurality of hardware components includes a microprocessor, a memory unit, a storage unit, a wireless communication module, at least one notification means, a power supply unit, a display unit, a plurality of sensors, at least one microphone, a loudspeaker, a vibrating motor and at least one of peripheral devices interconnecting means, enclosed inside a casing of the miniature portable electronic device, etc. The plurality of electronic devices of the system is connected over the wireless communication network for transferring a plurality of information and for providing at least one functionality to the miniature portable electronic device. The miniature portable electronic device 102 can also be used to communicate and control a plurality of functions such as controlling at least one wireless electronic device, and for measuring and transferring a plurality of information to the smart devices over the wireless communication network. The miniature portable electronic device is installed with at least one mini-app, which is specifically designed to run on the miniature portable electronic device for interacting with the plurality of hardware components of the miniature portable electronic device, the plurality of electronic devices and to the at least one user. The miniature portable electronic device is capable of being installed with the at least one mini-app by connecting the miniature portable electronic device to the plurality of electronic devices. In an embodiment, the miniature portable electronic device is connected using wireless means over the wireless communication network with the electronic device for installing and/or configuring the mini-apps on the miniature portable electronic device. The at least one mini-app installed in the miniature portable electronic device includes at least one independent mini-app and at least one dependent mini-app. The at least one independent mini-app running on the miniature portable electronic device has full functionality available and is capable of being processed and rendered completely from within the miniature portable electronic device with or without collaborating with the at least one smart device and/or the wireless electronic devices. The at least one dependent mini-app running on the miniature portable electronic device has partial functionality and is capable of being processed and rendered from within the miniature portable electronic device.

The miniature portable electronic device can interact with the plurality of electronic devices either directly from the device or using the mini-apps installed in the miniature portable electronic device through the wireless communication network. The at least one smart device of the system is capable of being installed with a plurality of smart device application selected from an online application store for providing a plurality of functionality to the at least one smart device. The user can select a plurality of smart device applications from the online store using the at least one smart device having Internet connectivity. The plurality of smart device applications installed in the at least one smart device is having at least one miniature device application specifically designed to run on the at least one smart device for interacting with the mini-apps installed on the miniature portable electronic device over the wireless communication network. The miniature device application designed to run on the at least one smart device for interacting with the mini-apps allows the user to configure at least one functionality of the miniature portable electronic device. Some of the at least one miniature device application specifically designed to run on the at least one smart device works in synchronous with the corresponding mini-app designed to run on the miniature portable electronic device by communicating over the wireless communication network. The plurality of smart device applications residing in the at least one smart device includes at least one counter-part mini-app of the at least one mini-app residing on the miniature portable electronic device. It will allow the user to add, remove and update the mini-apps from the corresponding miniature device application forming the counter mini-apps of the mini-apps installed in the miniature portable electronic device. The at least one smart device application recognizes at least one mismatch between the plurality of mini-apps on the miniature portable electronic device and the corresponding counter-part miniature device application running on the at least one smart device and displays at least one message to the user on the smart device to download updated data for the miniature device application from the remote web server(s) through Internet and/or from the portable memory storage device and thereafter updates the plurality of mini-apps on the miniature portable electronic device to remove any mismatch. The at least one smart device connected to the at least one miniature portable electronic device is capable of providing a plurality of on-demand functionality to the at least one miniature portable electronic device including configuring the plurality of smart device application and the at least one miniature device application from the at least one smart device connected to the at least one miniature portable electronic device over the wireless communication network. The at least one wireless electronic device is located in the vicinity of the miniature portable electronic device and connected to the miniature portable electronic device over the wireless communication network for allowing the at least one user to communicate and control the at least one wireless electronic device using the miniature portable electronic device. The miniature portable electronic device renders a subset of functionality and/or a full functionality of the at least one wireless electronic device through at least one specific mini-app on the miniature portable electronic device specifically designed to communicate with the at least one wireless electronic device. The at least one specific mini-app on the miniature portable electronic device designed to communicate with the at least one wireless electronic device can access at least one functionality and/or the full functionality of the at least one wireless electronic device remotely from within the miniature portable electronic device.

The at least one remote web server supports at least one function of the miniature portable electronic device and the at least one mini-apps residing in the miniature portable electronic device connected to the at least one remote web server over the wireless communication network. The miniature portable electronic device and the smart applications of the smart device including the miniature device applications designed to interact with the mini-apps residing in the miniature portable electronic device communicates with the at least one remote web server for receiving an update, a plurality of new applications in the smart devices and the miniature portable electronic device. The miniature portable electronic device and the smart devices communicates with the at least one remote web server over the wireless communication network The system includes at least one data repository residing in at the miniature portable electronic device at least one smart device at least one wireless electronic device, at least one remote web server and/or at least one portable memory storage device for storing a plurality of information. The miniature portable electronic device is capable of interacting with the at least one software application installed in the miniature portable electronic device, the smart devices, the wireless electronic devices, the remote web servers, and/or the portable memory storage devices over the wireless communication network.

Other objects and advantages of the embodiments herein will become readily apparent from the following detailed description taken in conjunction with the accompanying drawings.

### BRIEF DESCRIPTIONS OF THE DRAWINGS

FIG. 1 illustrates a system having a miniature portable electronic device connected to at least one smart device, at least one wireless electronic device and at least one remote web server over a wireless communication network according to a preferred embodiment of the present invention;

FIG. 2 illustrates a block diagram of the system having the miniature portable electronic device connected to the at least one smart device, the at least one wireless electronic device and the at least one remote web server over the wireless communication network according to a preferred embodiment of the present invention;

FIG. 3 illustrates a block diagram showing a plurality of components of the miniature portable electronic device in the system according to an embodiment of the present invention;

FIG. 4 illustrates a block diagram showing a plurality of components of the at least one smart device connected to the miniature portable electronic device in the system according to an embodiment of the present invention;

FIG. 5 illustrates a right-top perspective view of the miniature portable electronic device of the system that can be worn by at least one user for performing a plurality of functions according to an embodiment of the present invention;

FIG. 6 illustrates a left-bottom perspective view of the miniature portable electronic device of the system that can be worn by at least one user for performing a plurality of functions according to an embodiment of the present invention;

FIG. 7 illustrates a front view of the miniature portable electronic device of the system that can be worn by at least one user for performing a plurality of functions according to an embodiment of the present invention;

FIG. 8 illustrates a block diagram showing a high-level communication between software applications in the system according to an embodiment of the present invention;

FIG. 9 illustrates a block diagram showing a detailed communication between software applications in the system having a miniature portable electronic device connected to a plurality of smart devices, a plurality of wireless electronic devices and a plurality of remote web servers, according to an embodiment of the present invention;

FIG. 10 illustrates a block diagram showing a miniature application screen of the miniature application running on the smart device of the system according to an embodiment of the present invention; and

FIG. 11 illustrates a block diagram showing a features list screen of the miniature application running on the smart device of the system according to an embodiment of the present invention.

FIGS. 12A through 12E illustrate various embodiments of the miniature portable electronic device coupled to a ring accessory.

FIG. 13A illustrates an exploded perspective view of the miniature portable electronic device having the form factor of a finger ring.

FIGS. 13B and 13C are sequential illustrations of the miniature portable electronic device being fitted to an accessory.

FIG. 13D is an illustration of a miniature portable device coupled to a necklace accessory.

FIG. 14A is an illustration of a miniature portable device coupled to a keychain accessory.

FIG. 14B is an illustration of a miniature portable device coupled to a pen cap accessory.

FIG. 14C is an illustration of a miniature portable device coupled to a bracelet accessory.

FIG. 15A is a screenshot of a list of mini-apps displayed on a mini-app store.

FIG. 15B is an image of the miniature portable electronic device whereon a watch mini-app is being downloaded.

FIG. 15C is an image of a miniature portable electronic device being in form factor of a necklace being worn on the neck of a user.

FIG. 16A are illustration of the miniature portable electronic device displaying a first screen with a notification icon and a second screen displaying the notification.

FIG. 16B is a screenshot of a virtual QWERTY keypad displayed on the miniature portable electronic device.

FIG. 16C is an illustration of the miniature portable electronic device being wirelessly charged on a charging pad.

FIG. 16D is a screenshot of the description of an exemplary music mini-app on a mini-app store.

FIG. 16E is an illustration of a user operating the miniature portable electronic device playing music.

FIG. 17A, according to an embodiment of the present invention, illustrates an exploded perspective view of the miniature portable electronic device exposing the internal components thereof.

FIG. 17B is a schematic block diagram of the miniature portable electronic device.

FIG. 18A depicts the firmware block diagram of previous embodiment of the miniature portable electronic device depicted in FIG. 17B

FIG. 18B is block diagram of the top and bottom sides of the main board PCB of FIG. 18C.

FIG. 18C, according to an alternate embodiment of the present invention, is a stacked block diagram of the miniature portable electronic device that employs an application processor.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical, electrical and other changes may be made without departing from the scope of the embodiments. For instance, well-known methods, procedures, components, circuits, and networks have not been described in detail so as not to unnecessarily obscure aspects of the embodiments. It will also be apparent to one of ordinary skill in the art that the various described embodiments may be practiced without these specific details. The following detailed description and the accompanying drawing are therefore not to be taken in a limiting sense.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. More particularly, in this document, the term “or” is used to refer to a nonexclusive “or,” such that “A or B” includes “A but not B,” “B but not A,” and “A and B,” unless otherwise indicated. It will be further understood that the terms “includes”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The description provided herein is complete and sufficient for those skilled in the arts of systems, mobile application development and wearable tech development to implement the methods as described. The system and method described herein can be implemented on various configurations of hardware and software. The system can be comprised of various modules, tools, and applications as discussed below. As can be appreciated by one of ordinary skill in the art, each of the modules may comprise various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library. One embodiment of this system for interacting with a plurality of electronic devices may employ a server running an operating system such as variants of Windows, Macintosh, UNIX, Linux, VxWorks, or other operating system, web-server software such as Apache, and database such as MySQL, with methods implemented through a software development language such as, but not limited to, C, C++, C#, BASIC, Visual Basic, Pascal, Ada, Java, HTML, XML, or Java. However, the invention should not be limited to these types of software operating system, web-server software, database software, software development language, server or client hardware.

Before describing the details of the system, the following provides a number of useful possible definitions of terms used in describing certain embodiments of the disclosed invention.

### DEFINITIONS

### System

The proposed system having at least one miniature portable electronic device for interacting with a plurality of electronic devices including at least one smart device, at least one wireless electronic device and at least one remote web server connected to the miniature portable electronic device over a wireless communication network.

### System User

User who uses the proposed system. The user can employ the miniature portable electronic device of the system for interacting with the plurality of electronic devices including at least one smart device, at least one wireless electronic device and at least one remote web server connected to the miniature portable electronic device over the wireless communication network. The users can use the miniature portable electronic device for performing a plurality of functionalities such as making a call, changing channel of a TV, connecting to internet for searching for a content through voice search, etc.

### Smart Device

A device that is compatible for connecting with the miniature portable electronic device and/or to the wireless electronic device and the at least one remote web server for forming the system. The smart device is capable of providing on-demand functionality to the miniature portable electronic device and optionally additional or enhanced functionality to the at least one user of the system through its user interface. The smart device and the miniature portable electronic device are connected to each other over the wireless communication network. The smart device can be an iPhone, Android Phone, Windows 8 tablet, TiVo setup box, Google TV, etc., which allows installing and running a plurality of applications designed for providing a specific functionality or functionalities. The smart device supports an app model i.e. installation of 3rd party applications onto it and allows installing of miniature portable electronic device's smart device application(s) onto it. The smart device is always connected to Internet for sending and receiving a plurality of information from the Internet.

### Smart Device Application (is it a Platform App Supporting a Suite of Mini-Apps or the App Itself)

A functionality of the smart device app that can be downloaded and installed as software application on the smart device. It could be an on-demand functionality that the system user can download and install onto the smart device from an app store of the smart device i.e. for example iPhone's app store. The system user can also download a smart app over wired communication network e.g. iPhone connected via USB cable to laptop which in turn is connected via Ethernet cable to modem/router. Also the smart device application can be obtained for installation in the smart device by connecting the smart device to an internet-connected computer that fetches the functionality from the remote web server(s) of the smart device, say as part of an upgrade of the smart device. The smart device application can be functionality that the smart device's company installs on the smart device from time to time i.e. for example TiVo setup box. Once the smart device application is installed, the system users can open/run the application in the smart device to enjoy its features.

### Miniature Portable Electronic Device

A miniature portable electronic device comprises a wireless, portable electronic computing and communications device head, which is adapted to be interchangeably coupled to accessories. The device head includes a mini user interface for enabling a user to interact therewith, a computer memory, and a microprocessor disposed in operative communication with the memory and the user interface. Accessories comprise a finger ring, a pendant, a necklace, a bracelet, a keychain, an ear ring, a wallet-clipped emblem or badge, a shirt button cap or covering, a coat stud, a nose ring, a gadget clipped to a bangle, footwear, spectacles, a pocket-gadget, a table-top mini gadget, a refrigerator-door pasted gadget, a badge on shirt, an emblem on wrist band, head band, socks, cap hat, hair band, hair clip, pant suspenders, a pendant to handbag hangings, an emblem on shirt pocket, coat pocket, shirt sleeve, coat sleeve, an pen cap, tie clip, and a belt buckle. The device head is referred to as “ring head” in the event of the accessory being a finger ring.

### Miniature Device Application

These are the smart device applications specific to the miniature portable electronic device. It is installed on the smart device. It optionally contains counterpart mini-app(s) for the mini-apps installed on the miniature portable electronic device. The miniature device application communicates with the counter-part mini-app(s) in the miniature portable electronic device for performing at least one function.

### Mini Computer Application

A mini computer application, which, hereinafter, is referred to as simply a “mini-app”, is a functionality of miniature portable electronic device that can be downloaded and installed as software application on the miniature portable electronic device. This functionality of miniature portable electronic device could be an on-demand functionality that the system user can enable on system's smart device, which results in downloading and installing of this functionality on to the miniature portable electronic device, download and install onto the miniature portable electronic device by connecting the miniature portable electronic device to an internet-connected computer that fetches the functionality from remote web server(s) of system and/or from a portable memory storage device that contains the functionality. The mini-app may be a functionality that the miniature portable electronic device's company installs on the miniature portable electronic device from time to time for performing at least one function with the miniature portable electronic device. Once the mini-app is installed, the system users can open/run the mini-app on the miniature portable electronic device to enjoy its mini-features.

### Counterpart Mini Computer Application of Miniature Device Application

A counterpart mini computer application, which, hereinafter, is referred to as a “counterpart mini-app”, is installed on the smart device so as to provide functionality to Smart device in order to support and/or enhance the functionality of corresponding mini-app installed on the miniature portable electronic device. The functionality gets installed as software program on the smart device through install or upgrade of miniature device application on the smart device. Enabling or disabling this functionality on the miniature device application of the smart device results in installing/uninstalling of corresponding mini-app on the miniature portable electronic device as the Counter-part mini-app of Miniature device application in the smart device operates in sync with the corresponding mini-app in the miniature portable electronic device.

### App Store

A functionality on the smart device that lists all smart device applications of the smart device to the system user who can then optionally select a smart device application to download from remote web servers over the wireless communication network such as the internet and install on the smart device.

### Mini-App Store

A functionality on the smart device that lists all the mini-apps of the miniature portable electronic device to the system user who can then optionally select a mini-app to download from remote web servers over the wireless communication network such as the internet and install on the miniature device. The mini-apps are categorized into paid and free mini-apps. The mini-app store is alternatively referred to as a “device store.”

### Wireless Electronic Device

The Wireless electronic device is a device that may optionally be powered from a wire or cable and not necessarily a wire-free device but is compatible to connect with the miniature portable electronic device and capable of providing a plurality of functionality to the miniature portable electronic device. The wireless electronic device support connection and wireless communication with the miniature portable electronic device and it may optionally connect to Internet. Examples of wireless devices include Bluetooth-controlled doorbell system, Infrared-controlled Room Heater system, Bluetooth-controlled Car Alarm/Remote system, Infrared-controlled TV Remote system, automobile audio system, game console system, automation device, etc.

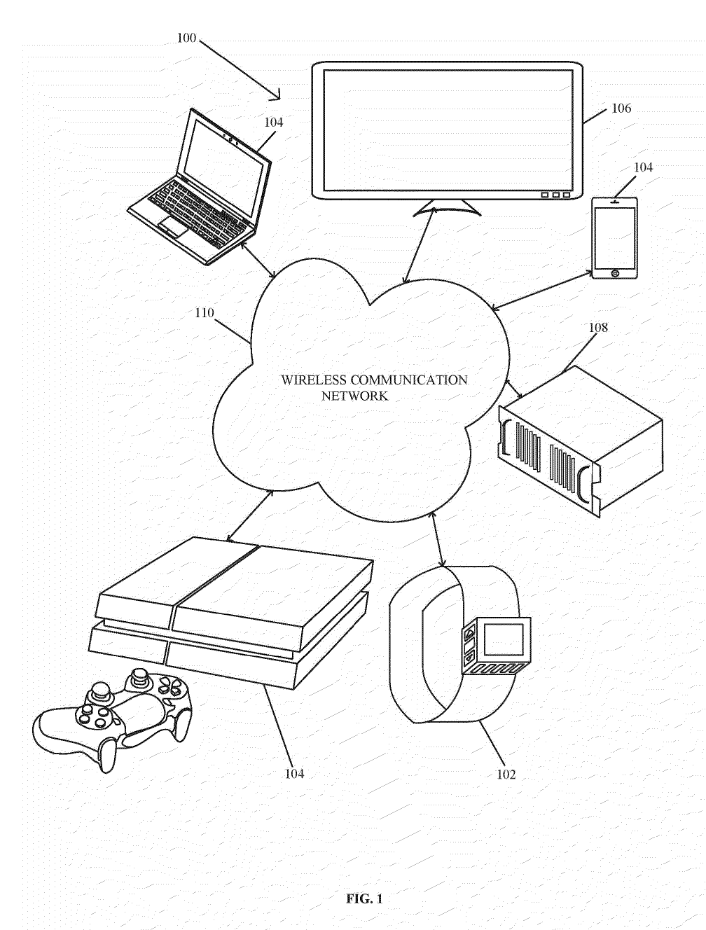

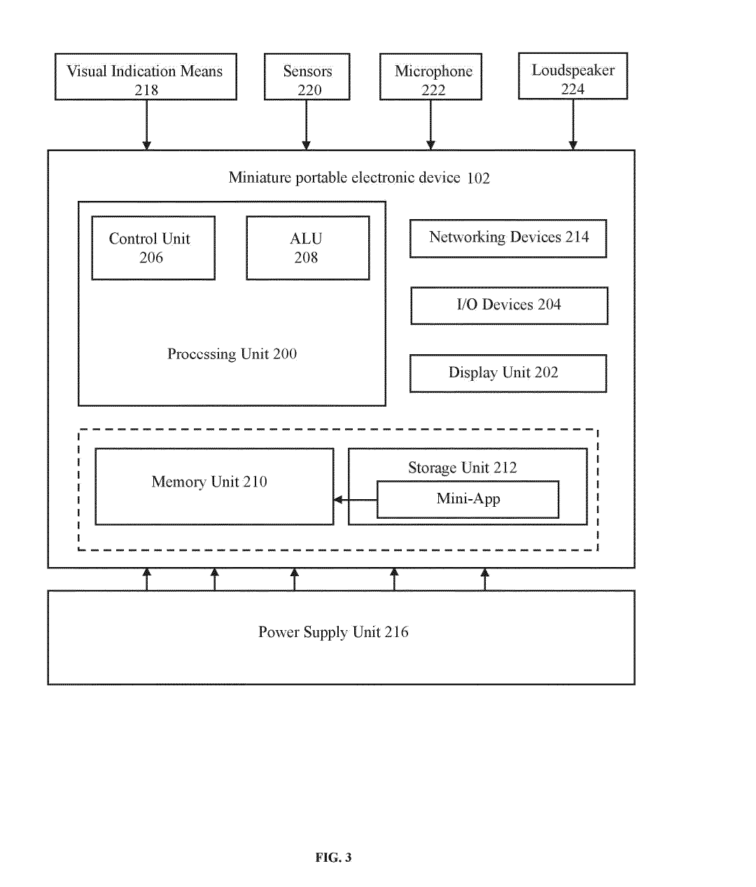

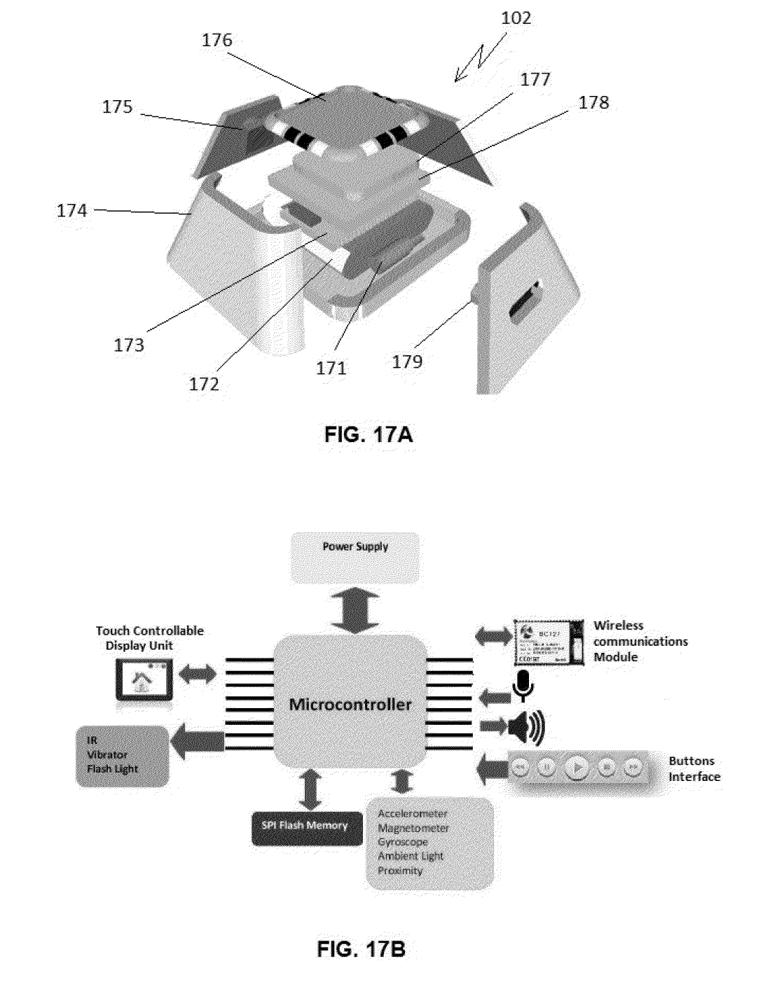

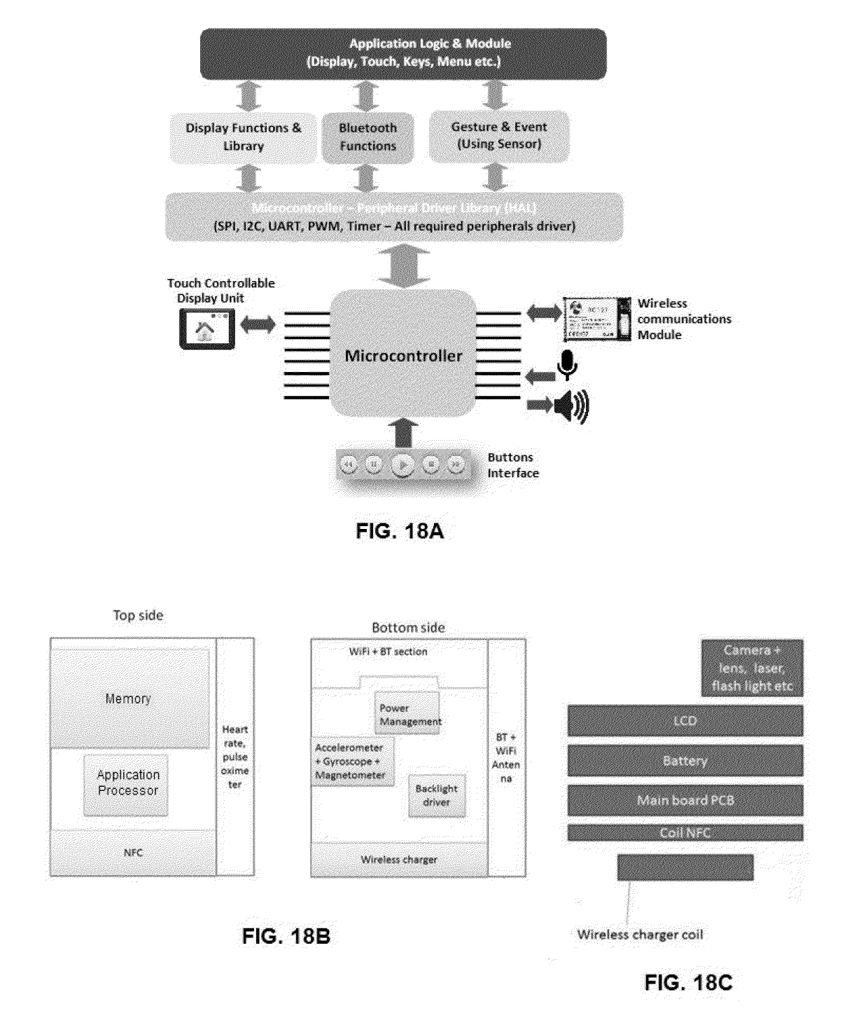

Referring now to FIG. 1, a system 100 having a miniature portable electronic device 102 for interacting with a plurality of electronic devices including at least one smart device 104, at least one wireless electronic device 106 and at least one remote web server 108 connected to the miniature portable electronic device 102 over a wireless communication network 110 according to a preferred embodiment of the present invention is disclosed. The miniature portable electronic device 102 having a plurality of hardware components capable of being operated by a plurality of instructions of a customized operating program installed in the miniature portable electronic device 102. As can be appreciated from FIGS. 3, 17A, 17B, 18B and 18C, the plurality of hardware components includes a microprocessor 200 or a microcontroller or an application processor, a memory unit 210, a storage unit 212, a wireless communication module, at least one notification means, a power supply unit 216, a display unit 177, a touch screen 177, a plurality of sensors, at least one microphone 222, a speaker 224, a protective lens 176, a micro-USB component 179, a vibrating motor (or a haptic actuator) 171 and at least one of peripheral devices interconnecting means, enclosed inside a casing 174 of the miniature portable electronic device 102, etc. In one embodiment as shown in FIGS. 17A, 17B, and 18A, the microcontroller 200, power management 216, etc., are disposed on a main board PCB 173, while the memory 210, a storage unit 212, wireless RF (radio frequency) communication circuitry, sensors 220, etc., are disposed on a second board PCB 178. The components further include a battery (power source) 172, a touch-controllable display unit 177, speaker & microphone unit 175, and an enclosure casing 174.

The components of RF (radio frequency) circuitry of device comprise an antenna system, an RF wireless transceiver, one or more amplifiers, digital signal processor, and subscriber identity module (SIM) card. The RF circuitry of device optionally communicates with networks, such as the Internet (World Wide Web), an intranet and/or a wireless network, such as a cellular telephone network, a wireless local area network (LAN) and/or a metropolitan area network (MAN), and other devices by wireless communication. The miniature portable electronic device 102 with RF capability performs functions such as radio-frequency identification scanners and/or readers.

The wireless communication module of miniature portable electronic device optionally use any of a plurality of communications standards, protocols and technologies, including but not limited to Global System for Mobile Communications (GSM), Enhanced Data GSM environment (EDGE), long term evolution (LTE), near field communication (NFC), code division multiple access (CDMA), Bluetooth, Wireless Fidelity (Wi-Fi), voice over Internet Protocol (VoIP), or any other suitable communication protocol, including communication protocols not yet developed as of the filing of this document.

FIG. 18A, which depicts the firmware block diagram of previous embodiment of FIGS. 17A and 17B, in one embodiment functions in a way that, if a smart device sends any commands to the miniature portable electronic device, the device head 101 will receive the event and capture all the data sent from the smart device and processes it in a dedicated loop of the firmware whereafter, the microprocessor takes an appropriate decision. Notably, the loop is dedicated loop for the functionality execution, where any event captured by the host processor will be processed in the main state diagram of the system firmware. The dedicated loop of the host processor stays and listens for incoming events based on interrupts and user interaction and performs the task.

Referring to FIGS. 18B and 18C, in one embodiment, the miniature portable electronic device is stacked with, among other things, a main board PCB, which includes an application processor 200, a wireless communications module, which includes a Wi-Fi and a Bluetooth module, a wireless charging module, and an NFC circuitry. FIG. 18B depicts a hardware block diagram of the top and bottom sides of the main board PCB, wherein the top side includes the application processor 200, a memory 210, the NFC circuitry, and the heart-rate sensor and wherein the bottom side includes the wireless communications module, a power management module 216, sensors 220 including an accelerometer, a gyroscope, and a magnetometer, a backlight driver, and a wireless charging module.

The charging for the miniature portable electronic device is done through wired charging system or through wireless charging system or through both. It can use standard system or a custom system specific for the miniature portable electronic device. The wireless power broadcasting unit of wireless charging system can be of any shape and size.

The plurality of electronic devices of the system 100 is connected over the wireless communication network 110 for transferring a plurality of information and for providing at least one functionality to the miniature portable electronic device 102. The miniature portable electronic device 102 can also be used to communicate and control a plurality of functions such as controlling at least one wireless electronic device 106, and for measuring and transferring a plurality of information to the smart devices 104 over the wireless communication network 110. The miniature portable electronic device 102 is installed with at least one mini-app, which is specifically designed to run on the miniature portable electronic device 102 for interacting with the plurality of hardware components of the miniature portable electronic device, the plurality of electronic devices and to the at least one user. The miniature portable electronic device 102 is capable of being installed with the at least one mini-app by connecting the miniature portable electronic device 102 to the plurality of electronic devices. In an embodiment, the miniature portable electronic device 102 is connected using wireless means over the wireless communication network 110 with the electronic device for installing and/or configuring the mini-apps on the miniature portable electronic device 102. The at least one mini-app installed on the miniature portable electronic device 102 includes at least one independent mini-app and at least one dependent mini-app. The at least one independent mini-app running on the miniature portable electronic device 102 has full functionality available and is capable of being processed and rendered completely from within the miniature portable electronic device 102 with or without collaborating with the at least one smart device 104 and/or the wireless electronic devices 106. The at least one dependent mini-app running on the miniature portable electronic device 102 has partial functionality and is capable of being processed and rendered from within the miniature portable electronic device 102.

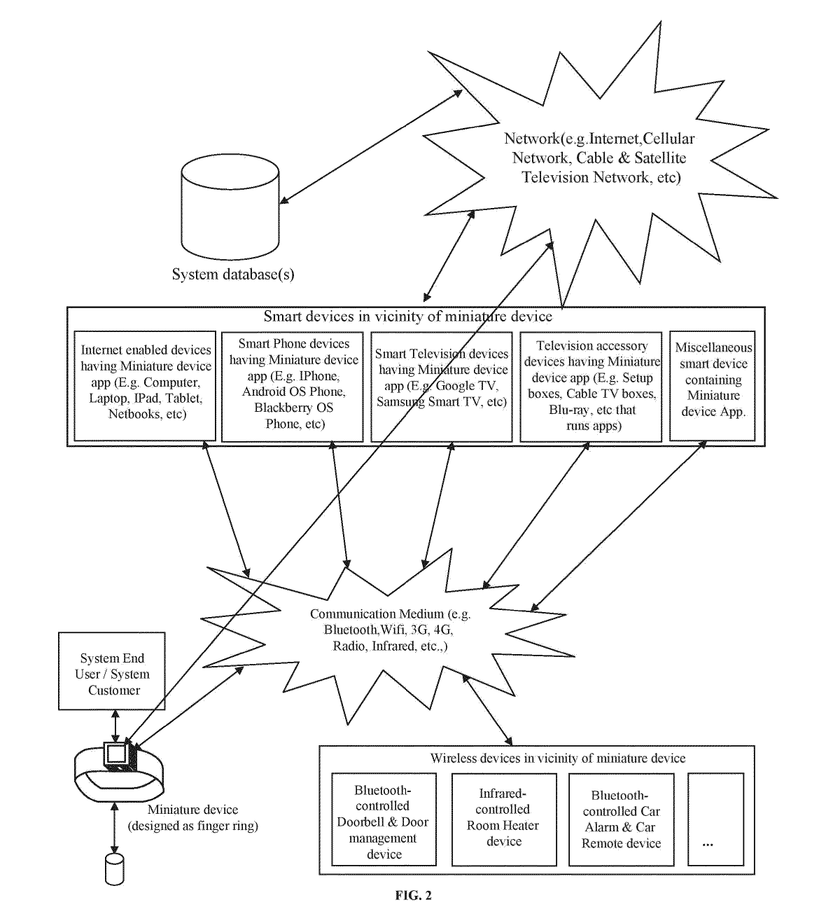

FIG. 2 illustrates a block diagram of the system 100 having the miniature portable electronic device 102 connected to the at least one smart device 104, the at least one wireless electronic device 106 and the at least one remote web server 108 over the wireless communication network 110 according to a preferred embodiment of the present invention. The miniature portable electronic device 102 can interact with the plurality of electronic devices either directly from the device or using the mini-apps installed in the miniature portable electronic device 102 through the wireless communication network 110. The at least one smart device 104 of the system 100 is capable of being installed with a plurality of smart device application selected from an online application store for providing a plurality of functionality to the at least one smart device 104. The user can select a plurality of smart device applications from the online store using the at least one smart device 104 having Internet connectivity. The smart device applications running on the at least one smart device 104 allows it to perform a plurality of functions such as productivity, entertainment, gaming etc. The plurality of smart device applications installed in the at least one smart device 104 is having at least one miniature device application specifically designed to run on the at least one smart device 104 for interacting with the mini-apps installed on the miniature portable electronic device over the wireless communication network 110. The miniature device application designed to run on the at least one smart device 104 for interacting with the mini-apps allows the user to configure at least one functionality of the miniature portable electronic device 102. Some of the counterpart apps work synchronously with the corresponding mini-app designed to run on the miniature portable electronic device 102 by communicating over the wireless communication network 110. The plurality of smart device applications residing in the at least one smart device 104 includes at least one counterpart mini-app of the at least one mini-app residing on the miniature portable electronic device 102. It will allow the user to add, remove and update the mini-apps from the corresponding miniature device application forming the counter mini-apps of the mini-apps installed in the miniature portable electronic device 102. The at least one smart device application recognizes at least one mismatch between the plurality of mini-apps on the miniature portable electronic device 102 and the corresponding counter-part miniature device application running on the at least one smart device 104 and displays at least one message to the user on the smart device 104 to download updated data for the miniature device application from the remote web server(s) 108 through Internet and/or from the portable memory storage device 112 and thereafter updates the plurality of mini-apps on the miniature portable electronic device 102 to remove any mismatch. The at least one smart device 104 connected to the at least one miniature portable electronic device 102 is capable of providing a plurality of on-demand functionality to the at least one miniature portable electronic device including configuring the plurality of smart device application and the at least one miniature device application from the at least one smart device 104 connected to the at least one miniature portable electronic device 104 over the wireless communication network 110. The at least one wireless electronic device (TV) 106 is located in the vicinity of the miniature portable electronic device 102 and connected to the miniature portable electronic device 102 over the wireless communication network 110 for allowing the at least one user to communicate and control the at least one wireless electronic device 106 using the miniature portable electronic device 102. The miniature portable electronic device 102 renders a subset of functionality and/or a full functionality of the at least one wireless electronic device 106 through at least one specific mini-app on the miniature portable electronic device 102 specifically designed to communicate with the at least one wireless electronic device 106. The at least one specific mini-app on the miniature portable electronic device 102 designed to communicate with the at least one wireless electronic device 106 can access at least one functionality and/or the full functionality of the at least one wireless electronic device 106 remotely from within the miniature portable electronic device 102.

The smart device (PS4) 104 connected to the miniature portable electronic device 102 includes Internet enabled devices such as, but not limited to, Computer, Laptop, iPad, Tablet, Netbooks, wearable devices, etc., having the at least one miniature device application for communicating with the miniature portable electronic device 102 and the plurality of mini-apps of the miniature portable electronic device 102. In addition, another groups of smart devices 104 include Smart Phone devices such as, but not limited to, iPhone, Android OS Phone, Blackberry OS Phone, Windows phone, Jolla phone, Ubuntu phone, etc., having the miniature device application installed in it. The smart devices 104 also includes Smart Television devices such as, but not limited to, Google TV, Samsung Smart TV, etc., and Television accessory devices such as, but not limited to, Setup boxes, Cable TV boxes, Blu-ray, etc., having the miniature device application capable of being interacting with the mini-apps residing on the miniature portable electronic device 102. The plurality of smart devices 104 is connected to the miniature portable electronic device 102 using the at least one wireless communication network 110 such as the Bluetooth, Wi-Fi, mobile data communication such as 3G, 4G, Radio, Infrared, etc. The miniature portable electronic device 102 can be connected to the smart devices 104 through the wireless communication network 110 for adding, removing or modifying at least one functionality of the miniature portable electronic device 102 and/or the plurality of smart devices 104. The miniature portable electronic device 102 can be worn by the user, as it is available as a ring, watch, etc., that can be worn onto the body of the user to communicate with the plurality of electronic devices using a plurality of preloaded mini-apps on it. The miniature portable electronic device 102 can also be used to perform a part of the functionality or full functionality of the wireless electronic devices 106, which is placed in vicinity of the miniature portable electronic devices 102. The plurality of wireless electronic devices 106 in communication with the miniature portable electronic devices 102 of the system 100 includes, but not limited to, Bluetooth-controlled doorbell and door management device, Infrared-controlled room heater device, Bluetooth-controlled car alarm and car remote device, etc. The plurality of wireless electronic devices 106 may include at least one application running on it to communicate with the miniature portable electronic devices 102 for allowing the user to perform a part of the full functionality or full functionality of the wireless electronic devices 106 remotely. The plurality of wireless electronic devices 106 is connected to the miniature portable electronic device 102 using the at least one wireless communication network 110 such as the Bluetooth, Wi-Fi, mobile data communication such as 3G, 4G, Radio, Infrared, near field communication (NFC) etc. or via the at least one smart device. The plurality of smart devices 104 is connected to the at least one remote web server 108, which supports at least one function of the miniature portable electronic device 102 and the at least one mini-apps of the miniature portable electronic device 102, at least one smart device application corresponding to the at least one mini-apps of the miniature portable electronic device 102, and at least one wireless electronic device specific application corresponding to the at least one mini-apps of the miniature portable electronic device 102 for interacting with the wireless electronic device 106. The at least one remote web server 108 supports at least one function of the miniature portable electronic device 102 and the at least one mini-apps residing in the miniature portable electronic device 102 connected to the at least one remote web server 108 over the wireless communication network 110. The miniature portable electronic device 102 and the smart applications of the smart device 104 including the miniature device applications designed to interact with the mini-apps residing in the miniature portable electronic device 102 communicates with the at least one remote web server 108 for receiving an update, a plurality of new applications in the smart devices 104 and the miniature portable electronic device 102. The miniature portable electronic device 102 and the smart devices 104 communicates with the at least one remote web server 108 over the wireless communication network 110 such as, but not limited to, internet, cellular network, cable and satellite television network, etc. The wireless electronic devices 106 communicates with the at least one remote web server 108 through the smart devices 104 communicating with the at least one remote web server 108 over the wireless communication network 110. The at least one remote web server 108 supports at least one function of the at least one mini-app designed to interface with the at least one wireless electronic device 106 and at least one function of the at least one miniature device application specifically designed to run on the at least one smart device 104. The system 100 includes at least one data repository residing in at the miniature portable electronic device 102 at least one smart device 104 at least one wireless electronic device 106, at least one remote web server 108 and/or at least one portable memory storage device for storing a plurality of information. The miniature portable electronic device 102 is capable of interacting with the at least one software application installed in the miniature portable electronic device 102, the smart devices 104, the wireless electronic devices 106, the remote web servers 108, and/or the portable memory storage devices over the wireless communication network 110.

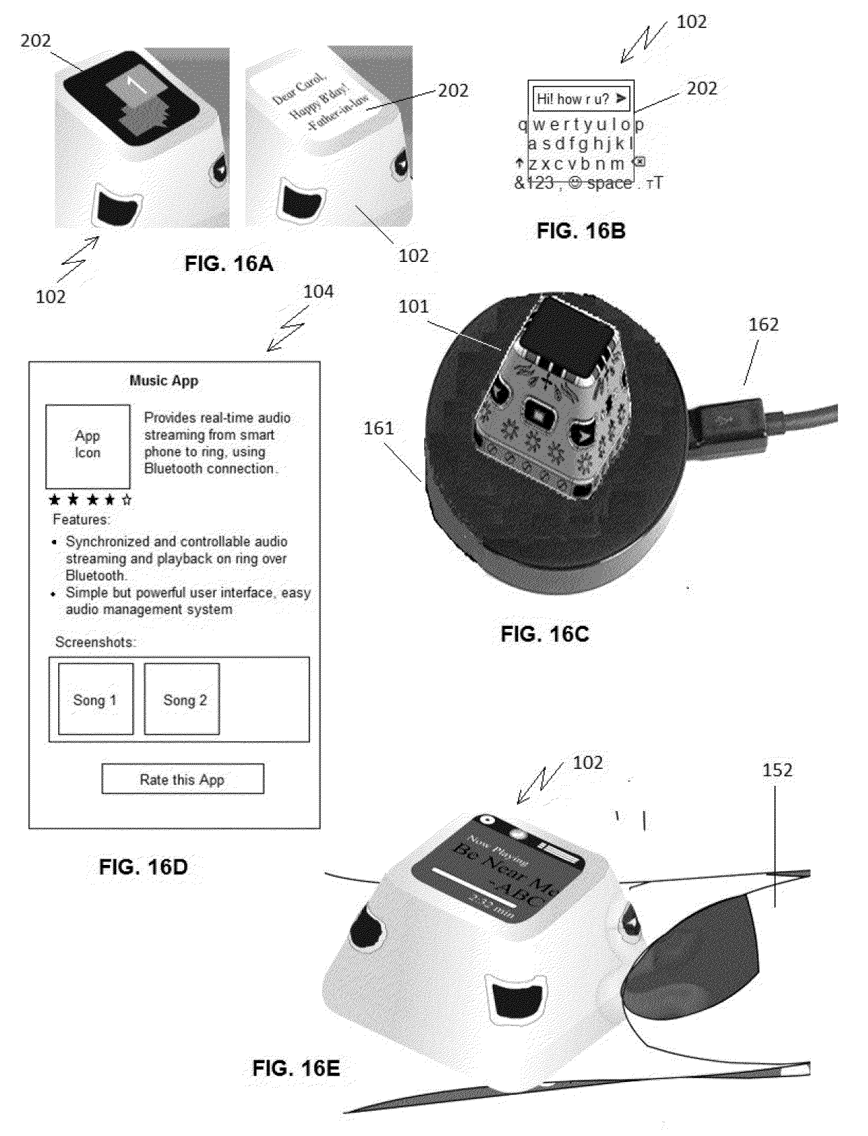

FIG. 3 illustrates a block diagram showing a plurality of components of the miniature portable electronic device 102 of the system 100 according to an embodiment of the present invention. The miniature portable electronic device 102 comprises a processing unit 200 such as a microprocessor for processing a plurality of information from the mini-apps and the operating program, and a plurality of information received by the miniature portable electronic device 102 from a plurality of sensors, a plurality of external electronic devices and a plurality of inputs from the at least one user, a memory unit 210 such as random access memory (RAM) unit for storing plurality of data and instructions while executing the at least one functionality of the miniature portable electronic device 102, at least one networking device 214 for communicating with the plurality of electronic devices including the smart devices 104, wireless electronic devices 106, and the remote web servers 108. The miniature portable electronic device 102 further includes an input-output unit or peripheral device interconnecting means 204 for connecting with a plurality of external electronic devices. One of the peripheral devices interconnecting means comprises a wireless recharge pad 161 employed for transmitting power to the miniature portable electronic device 102 wirelessly as shown in FIG. 16C. One of the peripheral devices interconnecting means comprises either a USB or a Micro-USB port 162 employed for charging purposes and data transfer purposes between the miniature portable electronic device and a smart device and between the miniature portable electronic device and the electronic device.

The miniature portable electronic device 102 further includes a display unit 202 for displaying a plurality of information from the mini-apps, the plurality of sensors, plurality of information received from the plurality of electronic devices such as the smart devices 104, the wireless electronic devices 106 and the remote web server 108, a plurality of notifications, alerts etc. The plurality of mini-apps and the other information are stored inside a storage unit 212 such as a flash memory of the miniature portable electronic device 102, which allows reading and writing data from/into it whenever required. The at least one networking device 214 includes an embedded Wi-Fi module enabling wireless communication and a Bluetooth controller providing enhanced data rate for short-range wireless data exchange between the miniature portable electronic device 102 and the smart devices 104 or to the wireless electronic devices 106. The embedded Wi-Fi module and the Bluetooth controller may be provided as a combo module component within a casing of the miniature portable electronic device 102. The miniature portable electronic device 102 is powered by using at least one power supply unit 216 such as, but not limited to, a rechargeable lithium-ion polymer battery having sufficient capacity to avoid frequent charging. The power supply unit 216 takes approximately two hours to reach full charge from a low battery and may last for seven days with occasional use, or five days with frequent notifications and backlight activation such as in case of continuous audio recording mini-app residing in the miniature portable electronic device 102 for recording audio or when miniature portable electronic device such as the finger ring is set to glow with light instead of being set to vibrate and/or output audio sound. However using a different type of battery or the same battery having improved capacity may change these values. In one embodiment, the miniature portable electronic device's device head 101 is charged wirelessly by employing a wireless charging pad or dock 161 connected to power outlet using a micro-usb charging cable 162 as seen in FIG. 16C. The processing unit 202 include an arithmetic and logic unit (ALU) 208 and a control unit 206 for providing a plurality of instructions there by enabling the miniature portable electronic device 102 to perform at least one function of the smart devices 104 or the wireless electronic device 106 or the own functions of the miniature portable electronic device 102. The miniature portable electronic device 102 includes a backlit light means functioning as at least one visual indication means 218 for the at least one notification, alert etc. The display unit 202 is a LCD or OLED or AMOLED display unit having sufficient resolution and pixels density to enable easy viewing by the users. In an embodiment, the display unit 202 is a sharp memory LCD having better outdoor readability, which is obtained by using a specific type of e-paper that has the excellent contrast of e-ink with a higher-level refresh rate. In some embodiment, the display unit 202 is a color screen having touch sensitivity to allow the user to provide a plurality of input through at least one gesture on the touch screen. The display unit 202 is covered using an antiglare optical coating, which is both scratch and shatter resistant thereby protecting the screen from getting damaged while in use. A plurality of sensors 220 of the miniature portable electronic device 102 includes, but not limited to, accelerometer sensor, ambient light sensor, motion sensor, optical sensor, contact intensity sensor, proximity sensor, gyroscope, magnetometer, etc. The miniature portable electronic device 102 includes at least one microphone 222, a loudspeaker 224 for making calls via the smart device 104 such as the smartphone and for making emergency calls directly from the miniature portable electronic device 102. The loudspeaker 224 also provides an audio notification to the user. In some embodiments, the microphone 222 allows the user to provide a plurality of audio instructions to the miniature portable electronic device 102 for performing at least one task. The miniature portable electronic device 102 further includes a vibrating motor for providing a notification or alert to the user by vibrating the miniature portable electronic device 102. The plurality of components of the miniature portable electronic device 102 is enclosed inside a casing made of at least one materials such as but not limited to metal, plastic etc. In some embodiments, the casing covers the miniature portable electronic device 102 so as to make it dust and waterproof. In some other embodiments, the casing of the miniature portable electronic device 102 is having rubber or any other materials to make it as a rugged device. In some other embodiments, the miniature portable electronic device 102 key is used to interact with, change state of, or otherwise affect one or more external electronic devices.

It should be noted that device 102 as shown in FIG. 3 is only one example of a miniature device, and that device 102 optionally has more or fewer components than shown, optionally combines two or more components, or optionally has a different configuration or arrangement of the components. The various components shown in FIG. 3 are implemented in hardware, software, firmware, or a combination thereof, including one or more single processing and/or application specific integrated circuits.

Peripherals interface 204 of the device can be used to couple input and output peripherals of the device to CPU(s) 200 and Memory 210. The one or more processors 200 run or execute various software programs and/or sets of instructions stored in Memory 210 to perform various functions for device 102 and to process data.

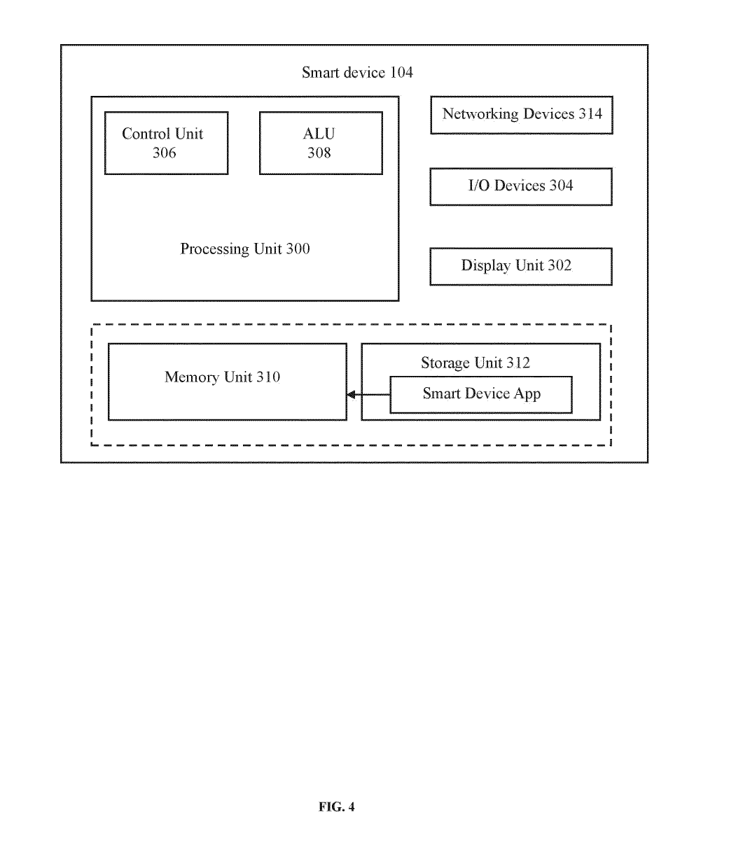

FIG. 4 illustrates a block diagram showing a plurality of components of the at least one smart device 104 connected to the miniature portable electronic device 102 of the system 100 according to an embodiment of the present invention. The at least one smart device 104 of the system 100 includes any networkable device having internet connectivity such as, but not limited to, a PC, laptop, desktop, tablet, smart wearable devices, etc. having the plurality of smart device application installed in the plurality of smart devices 104 for performing a plurality of functions such as interacting with the miniature portable electronic device 102, the wireless electronic device 106 and to the remote web server 108. The remote web server 108 of the system 100 is used for storing and processing the plurality of information including the plurality of smart device applications, the plurality of mini-apps and the plurality of software for the smart devices 104 and the wireless electronic device 106. The users can download the smart device applications, the plurality of mini-apps and the plurality of software to their at least one smart device 104. The smart device applications can be launched from the smart devices 104 such as, but not limited to, a computer, Smartphone or a tablet computer and can be used to receive the plurality of information provided by the user and to communicate with the mini-apps on the miniature portable electronic device 102 by sending the information over the wireless communication network 110. The at least one smart device 104, which includes, but is not limited to, a Smartphone, tablet, ultrabook, laptop, smart wearable device including Google Glass, Smartwatch etc., includes at least one processing unit 300 configured to process a number of applications including the smart device applications and the miniature device applications among the smart device applications specially designed to communicate with the mini-apps of the miniature portable electronic device 102. The miniature device applications residing on the smart device 104 and capable of communicating with the mini-apps of the miniature portable electronic device 102 may form a counter mini-app of the mini-app residing on the miniature portable electronic device 102. The counter mini-app of the miniature device applications residing on the smart device 104 can be accessed by the user to update, delete, add a plurality of functions of the mini-apps of the miniature portable electronic device 102, thereby he/she can remotely configure the mini-apps of the miniature portable electronic device 102 from within the smart device 104. Wherever changes made to the counter mini-app of the miniature device applications residing on the smart device 104 will be reflected to the mini-app residing on the miniature portable electronic device 102 and vice versa and the changes will be transferred over the wireless communication network 110. The smart device applications installed in the smart devices 104 allows the plurality of users to provide a plurality of inputs through a user interface. The processing unit 300 processes the plurality of inputs provided by the user and may change a plurality of functionality of the smart device application and transfers the data from the smart device 104 to the miniature portable electronic device 102 over the wireless communication network 110 for updating the corresponding mini-app residing on the miniature portable electronic device 102.

In an embodiment of the present invention, the processing unit 300 is configured to process a plurality of instructions from at least one smart device application including the plurality of miniature device applications designed to allow the plurality of users to provide a plurality of inputs for the mini-apps residing on the miniature portable electronic device 102 through its user interface. The at least one smart device application allows the users to submit a plurality of information through the user interface for submitting to the mini-apps residing on the miniature portable electronic device 102 thereby adding, deleting, updating at least one functionality of the miniature portable electronic device 102. In some embodiments, the mini-apps installed on the miniature portable electronic device 102, which is communicating over the wireless communication network 110, has the capability to access a plurality of functions of the smart device 104 including the capability to launch the at least one camera module of the smart device 104 and can access a storage area of the at least one smart device 104 for capturing and saving the at least one video or a plurality of images. The at least one smart device 104 includes a variety of hardware and associated software components, where the variety of hardware components include the processing unit 300 designed to control various other circuits such as information displayed on a display 302. The display 302 can display a user interface of the at least one smart device application. Moreover the display 302 may include at least one touch screen technology allowing the plurality of users to control the user interface of the at least one smart device application using at least one gesture or touch. The processing unit 300 may control the information based on inputs received from various input/output (I/O) devices 304 of the at least one smart device 104 e.g. hard keys, a touch screen, voice commands from a microphone or a microphone connected to headset jack, and/or from some other user input device. The at least one smart device 104 comprises the at least one processing unit 300 that is equipped with a control unit 306 and an Arithmetic Logic Unit (ALU) 308, a memory unit 310, a storage unit 312, a plurality of networking devices 314 and the plurality input/output (I/O) devices 304. The at least one smart device 104 can be composed of multiple homogeneous and/or heterogeneous cores, multiple CPUs of different kinds, special media and other accelerators. The processing unit 300 may also include a memory that stores data. The processing unit 300 might include only one of a type of component e.g. one microprocessor, or may contain multiple components of that type e.g. multiple microprocessors. The processing unit 300 could be composed of a plurality of separate circuits and discrete circuit elements. In some embodiments, the processing unit 300 will essentially comprise solid-state electronic components such as a microprocessor e.g. microcontroller. The processing unit 300 may be mounted on a single board in a single location or may be spread throughout multiple locations, which cooperate to act as processing unit 300. In some embodiments, the processing unit 300 may be located in a single location e.g. in proximity and/or on a common circuit carrying element such as a circuit board and/or all the components of the processing unit 300 will be closely connected. The smart device application has an algorithm for verifying and manipulating and to communicate the plurality of information received from the plurality of users and is stored inside the storage unit 312 and made available to the memory unit 310 during execution by the smart device application. The processing unit 300 is responsible for processing the instructions of the algorithm. The processing unit 300 receives commands from the control unit 306 in order to perform its processing. Further, the plurality of processing units 300 may be located on a single chip or over multiple chips. In addition, any logical and arithmetic operations involved in the execution of the instructions are computed with the help of the ALU 308. The storage unit 312 stores the smart device application and the memory unit 310 stores the data during run-time.

The at least one smart device 104 can be connected to the miniature portable electronic device 102 over the wireless communication network 110 for providing a plurality of on-demand functionality to the miniature portable electronic device 102 including addition, upgrade and deletion of the at least one miniature device application on the at least one smart device 104. The at least one smart device 104 allows the at least one miniature device application running on the at least one smart device 102 to access at least one device function of the at least one smart device 104 needed to support at least one function of the miniature portable electronic device 102. The at least one smart device 104 allows the user to install a plurality of third party applications from an online app store or from a portable storage device over the wireless communication network such as the internet. The at least one smart device 104 provides a plurality of functionality to the at least one user through a user interface of the miniature device application running on the at least one smart device 102, the plurality of functionality of the at least one smart device includes addition, installation, upgrading and deletion of a plurality of third party smart device applications and the plurality of miniature device applications from the online application store. The at least one smart device 104 includes Internet enabled devices having miniature device application such as, but not limited to, computer, Laptop, iPad, Tablet, Netbooks, Smart Phone devices having Miniature portable electronic device app application such as, but not limited to, iPhone, Android OS Phone, Blackberry OS Phone, Windows phone, Ubuntu phone, Jolla phone, Tizen operating devices such as smartphones and wearable, etc., Smart Television devices having Miniature device application such as, but not limited to, Google TV and other Smart TV, Television accessory devices having Miniature device application such as, but not limited to, Setup boxes, Cable TV boxes, Blu-ray, etc., that runs apps, gaming consoles having Miniature device application such as, but not limited to, Xbox, PlayStation, etc., having internet connectivity and is connected to the miniature portable electronic device 102 over the wireless communication network 110 for transferring a plurality of information using the at least one miniature device application specifically designed to run on the at least one smart device 104 for communicating with the miniature portable electronic device 102 of the system 100. At least one functionality of the miniature portable electronic device 102 can be altered by changing that on the at least one miniature device application working in synchronous with the corresponding mini-app on the miniature portable electronic device, i.e. smart device's 104 miniature device application forming the counter mini-app of the mini-app residing on the miniature portable electronic device 102. The mini-apps included in the miniature portable electronic device 102 includes Watch app, alarm app, weather app, ergonomics app, Music app, sleep-monitor app, Camera app etc. The user can download and install more apps to miniature portable electronic device 102, which is available in different forms such as, but not limited to, rings, watches, etc., including location-aware apps and context-aware apps by connecting to the remote web server 108. The miniature portable electronic device 102 can be used as a universal remote control to control TV, Blu-ray player, music system etc., and other Infrared-controllable appliances from the device. In some embodiments, the miniature portable electronic device 102 can effectively be used to control user's smartphone and vice versa.

The at least one mini-app running on the miniature portable electronic device 102 interacts with the at least one wireless electronic device 106 located in vicinity of the miniature portable electronic device 102 via the wireless communication network 110 such as, not limited to, Bluetooth, Wi-Fi, third generation mobile communication network (3G), fourth generation mobile communication network (4G), Radio, Infrared, near field communication (NFC), etc., for accessing and controlling a plurality of functionality of the at least one wireless electronic device 106 remotely. The wireless electronic device 106 may have Internet connectivity and can be fully controlled by the miniature portable electronic device 102 or the device itself. For example, the miniature portable electronic device 102 can be used to change the channels of a television directly by using infrared signals without using any mini-apps installed in the device 102. The independent mini-apps running on the miniature portable electronic device 102 have the full functionality being processed and rendered completely from within the miniature portable electronic device by collaborating with and/or without the at least one smart device 104 and/or the wireless electronic devices 106. For example, mini-apps depending the operation of the plurality of sensors such as the accelerometer of the miniature portable electronic device 102 may not need additional inputs for measuring the sensor data. However, the at least one dependent mini-app running on the miniature portable electronic device 102 have only partial functionality and need to be processed and rendered through the plurality of mini-apps running on the miniature portable electronic device 102 and displays the plurality of information through the display unit 202. The display unit 202 of the miniature portable electronic device 102 is an LCD display screen and displays icons, symbols, labels, few letters, few words, small sentences and signs. The miniature portable electronic device 102 may include control or navigation buttons for allowing the at least one user to scroll through the plurality of mini-apps installed in the miniature portable electronic device 102. The plurality of functions performed by the at least one miniature device application running on the at least one smart device 104 includes configuring a plurality of settings of the at least one mini-app, managing the at least one mini-app by adding and/or removing the mini-apps, extending the functionality of the at least one mini-app, leveraging at least one sensor of the smart device 104, which is not available in the miniature portable electronic device 102, providing a bigger display screen, larger processing power, larger memory, higher configuration settings of the smart device 104. In an embodiment, the at least one mini-app is installed to the miniature portable electronic device 102 by connecting the miniature portable electronic device 102 to the plurality of electronic devices via the wireless communication network 110 and/or using the at least one peripheral device interconnecting means 204 associated with the miniature portable electronic device 102. The at least one peripheral device interconnecting means 204 includes at least one universal serial bus port (USB) and/or micro-USB port for allowing the miniature portable electronic device 102 to be connected with the plurality of external electronic devices including a desktop computer, laptop, tablet, smartphone and smart wearable devices using a USB cable connected to the USB and/or micro-USB port for adding, updating, upgrading and removing the at least one mini-app on the miniature portable electronic device 102. The plurality of external electronic device includes at least one universal serial bus port (USB) and/or the micro-USB port for data transfer and it also performs as a means to charge the miniature portable electronic device 102. The at least one electronic device connected to the miniature portable electronic device 102 through the at least one universal serial bus port (USB) and/or micro-USB port using the USB cable receives data for adding, updating, upgrading and removing the at least one mini-app on the miniature portable electronic device 102 from the remote web server(s) 108, Internet and/or from the portable memory storage devices. When the external electronic device is connected to the miniature portable electronic device 102 using the USB cable, the at least one smart device application residing on the smart device 104 recognizes at least one mismatch between the plurality of mini-apps on the miniature portable electronic device 102 and a corresponding counter-part miniature device application running on the at least one smart device 104 and displays at least one message to the user on the smart device 104 to download updated data for the miniature device application from the remote web server(s) 108 through Internet and/or from the portable memory storage device. The downloaded data will be updated to the plurality of mini-apps on the miniature portable electronic device 102 to remove any mismatch. The at least one mini-app residing on the miniature portable electronic device 102 communicates with the at least one smart device application functioning in form of the at least one counterpart mini-app of the at least one mini-app residing on the miniature portable electronic device 102 over the wireless communication network 110 performs at least one call to at least one function of the at least one smart device 104 for serving at least one need of the at least one mini-app residing on the miniature portable electronic device 102. In some instances, the at least one mini-app residing on the miniature portable electronic device 102 performs at least one call to the at least one remote web server 108 through the internet for serving at least one need of the at least one mini-app residing on the miniature portable electronic device 102. In some instances, the user can perform an on-demand addition, upgrade and removal of at least one mini-app to the miniature portable electronic device 102 by selecting the at least one mini-app to add, upgrade and remove from the miniature portable electronic device 102. The at least one mini-app can be selected from a list of mini-apps displayed on a user interface of the miniature portable electronic device's smart device application residing on the smart device 104. The plurality of software updates are received by the smart device 104 from the remote web server 108 through the internet and the updates are regularly pushed to the miniature portable electronic device's smart device application running on the smart device 104 for adding, upgrading and removing the at least one mini-app in the miniature portable electronic device 102. The plurality of instructions for adding, upgrading and removing the at least one mini-app in the miniature portable electronic device 102 and the plurality of data for adding and upgrading the at least one mini-app is transferred over the wireless communication network and/or wired connection using the USB cable connecting the miniature portable electronic device 102 and the smart device 104. In some instances, the miniature portable electronic device's smart device application running on the smart device 104 allows the user to manually copy and install the plurality of software updates from the rom the portable memory storage device. The smart device 104 performs regular software updates checks for the plurality of smart device applications including the miniature device application and the miniature portable electronic device's smart device application.

The system 100 allows the users to select the at least one mini-app from the list of mini-apps displayed on the user interface of the miniature portable electronic device's smart device applications to add at least one mini-app's functionality to the miniature portable electronic device 102 and the smart device application on the smart device 104. The process of adding at least one mini-app's functionality to the miniature portable electronic device 102 is performed through transferring of a plurality of files of the at least one mini-app including compiled code files, mini-app icon, other graphics and data files from the smart device 104. The plurality of files for configuring the at least one mini-app's functionality to the smart device application residing on the smart device 104 is received from the remote web server 108 through the Internet. Users can remove the at least one mini-app and/or at least one functionality of the at least one mini-app selected from the list of mini-apps of the miniature portable electronic device 102 displayed on the user interface of the miniature portable electronic device's smart device applications on the smart device 104. The removal of the at least one mini-app and/or at least one functionality of the at least one mini-app selected from the list of mini-apps in turn removes the at least one functionality of the at least one mini-app on the miniature portable electronic device 102 and the at least one mini-app's functionality on the smart device application residing in the smart device 104. During the process of removing the at least one mini-app includes removal of the plurality of files of the at least one mini-app including compiled code files, mini-app icon, other graphics and data files from the smart device 104 and the miniature portable electronic device 102. In some instance, the removal of at least one functionality of the at least one mini-app selected from the list of mini-apps on the smart device 104 is performed by disabling the at least one functionality of the smart device application residing on the smart device 104.

The miniature portable electronic device 102 is connected to the plurality of wireless electronic devices 106 such as, but not limited to, Bluetooth-controlled doorbell system, infrared-controlled room heater system, Bluetooth-controlled car alarm/remote system, infrared-controlled TV remote system etc., over the wireless communication network 110 for providing at least one functionality such as activating/deactivating the doorbell, start/stop operation of the room heater, automatic car lock, TV channel control etc., through the miniature portable electronic device 102. Some of the plurality of wireless electronic devices 106 allows for full control of its functionalities and some other plurality of wireless electronic devices 106 only allows the miniature portable electronic device 102 to have partial functionality through the at least one mini-app residing on the miniature portable electronic device 102 and in communication with the at least one software of the plurality of wireless electronic devices 106. In some instances, the at least one mini-app residing on the miniature portable electronic device 102 is specific to the at least one software residing on the wireless electronic device 106 for passing the at least one functionality and/or the full functionality of the wireless electronic device 106 to the miniature portable electronic device 102 after making supported device programming calls to the wireless electronic device 106. According to the system 100 of the present invention, the miniature portable electronic device 102 is capable of interacting with a plurality of software application for transferring data to/from the at least one data repository associated with the software application and residing in the miniature portable electronic device 102, the at least one smart device 104, the at least one wireless electronic device 106, the at least one remote web server 108 and/or at least one portable memory storage device.

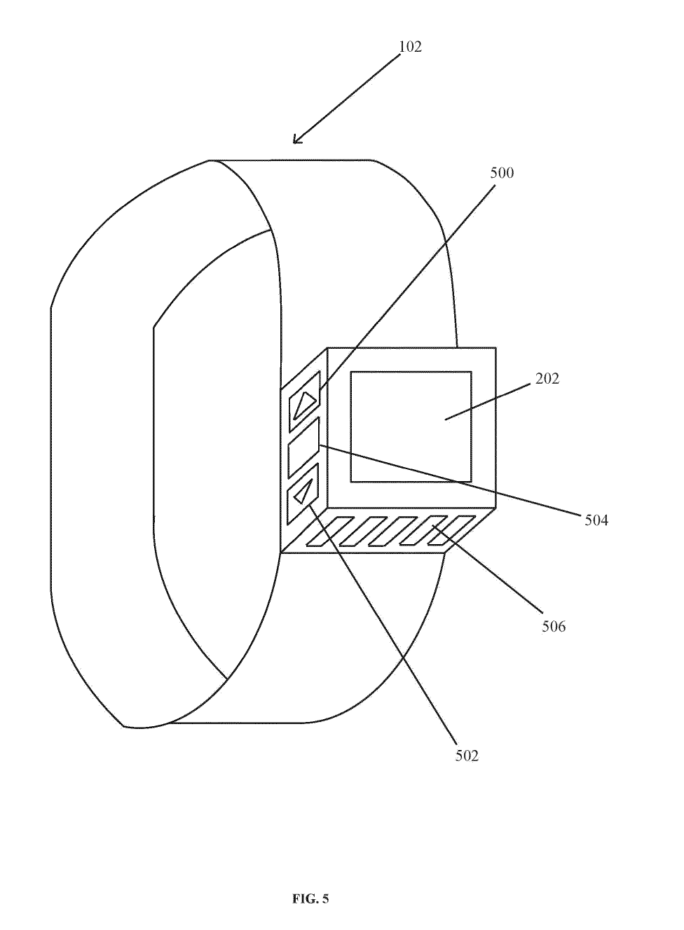

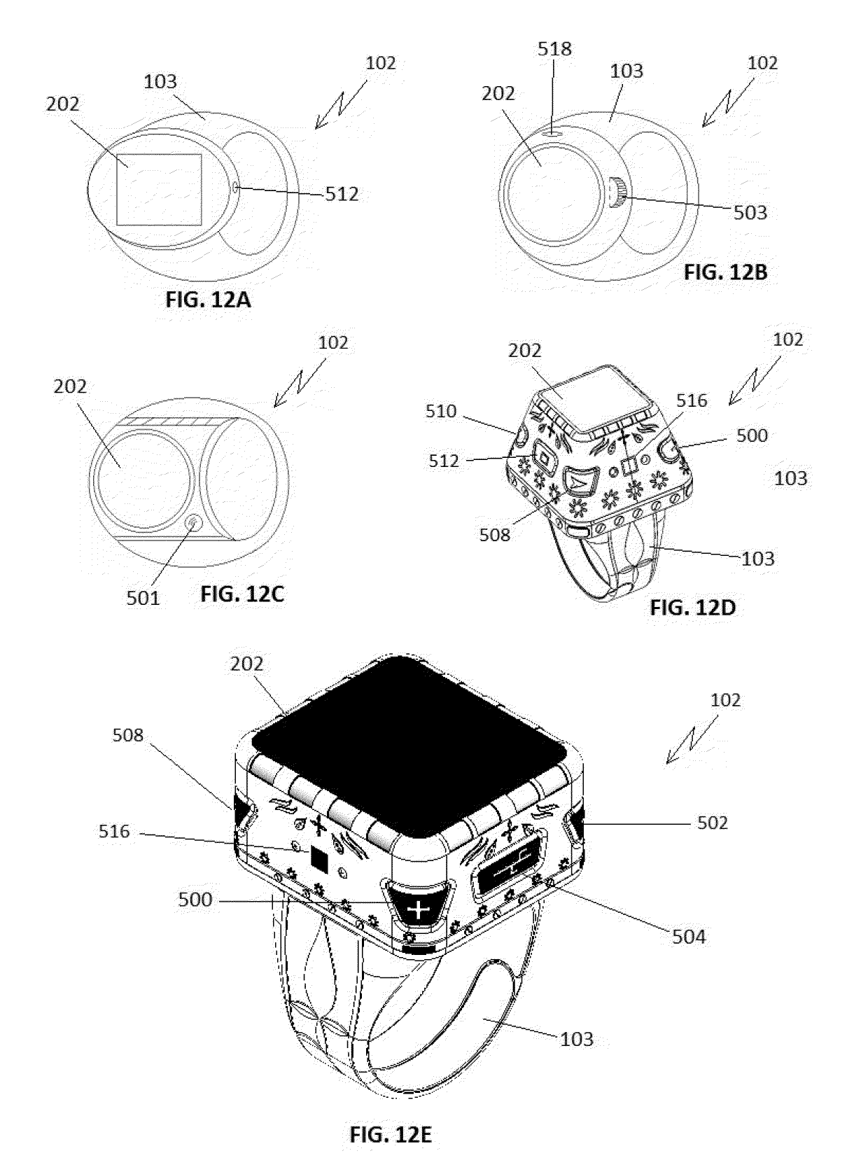

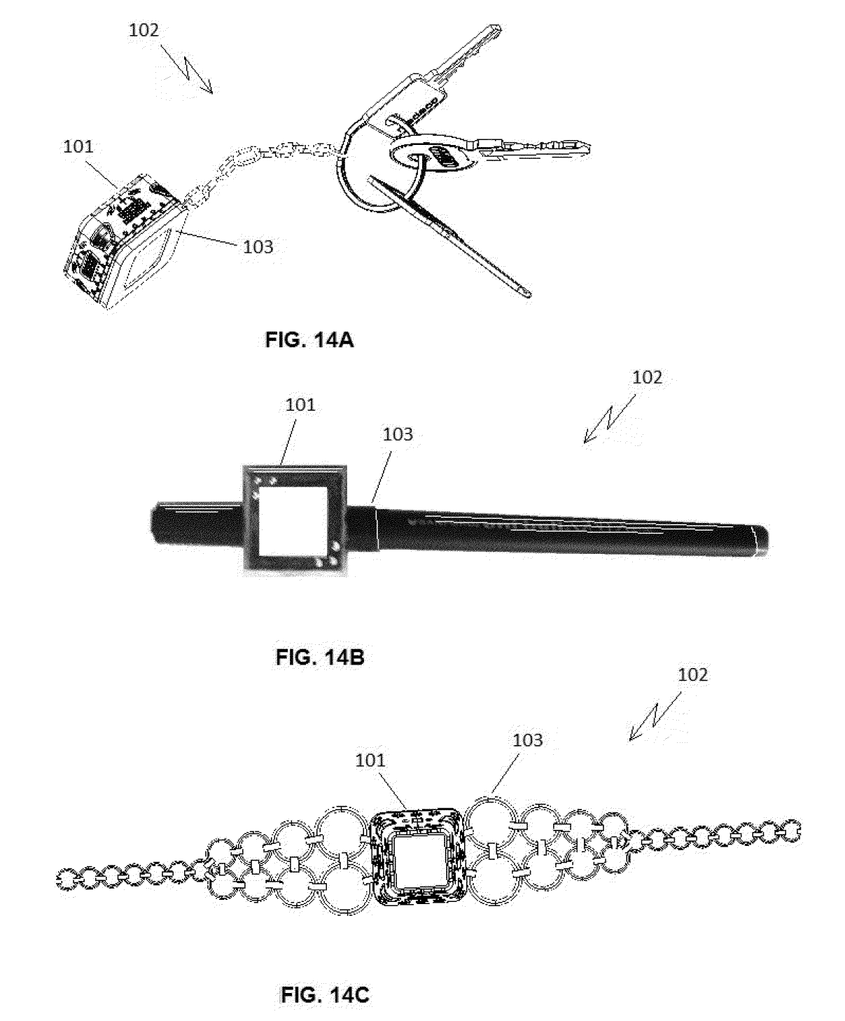

FIG. 5 illustrates a right-top perspective view of the miniature portable electronic device 102 of the system 100 that can be worn by at least one user for performing a plurality of functions according to an embodiment of the present invention. The miniature portable electronic device 102 has dimensions of up to 0.5 inch height, up to 0.5 inch width and up to 0.5 inch depth but may extend up to 1 inch height, up to 1 inch width and up to 0.8 inch depth depending on the encasement of the miniature portable electronic device 102. As can be appreciated from FIGS. 12A through 12E, the size and shape of the miniature portable electronic device 102 can be varied depending on the size and shape of the casing. More particularly, the shape of the casing in FIGS. 12A through 12C are circular, while the shapes of the casings in FIGS. 12D and 12E are pyramidal and rectangular respectively. Different cases and accessories 103 with various form factors are available to the miniature portable electronic device 102 to use it as a finger ring, pendant to neck chain, key chain, ear mounted device/ear ring/ear hanging, wallet-clipped emblem/badge, shirt button cap/covering, coat stud, fancy nose ring, gadget clipped to a bangle/footwear/spectacles, pocket-gadget, table-top mini gadget in office/home, refrigerator-door pasted gadget, badge on shirt, emblem on wrist band/head band/socks/cap/hat/hair band/hair clip/pant suspenders, pendant to handbag hangings, emblem on shirt pocket/coat pocket/shirt sleeve/coat sleeve, accessory on pen/pen cap, tie clip, detachable accessory on waist belt buckle etc. In FIGS. 14A through 14C, the miniature portable electronic device is being exemplarily used in the form of a keychain, a pen cap and a bracelet respectively. The miniature portable electronic device is available in a plurality of sizes, shapes, colors and materials for addressing a plurality of preferences of the user including fit, style and color.

In one embodiment, the miniature portable electronic device 102 is represented as a finger ring. The miniature portable electronic device 102 in form of the finger ring is having the touch screen display 202 for displaying the plurality of information, such as alerts, reminders, time weather etc. This plurality of information may be obtained from the user interface of the mini-apps installed in the miniature portable electronic device 102. The plurality of alert information is displayed on the user interface of the display screen of the miniature portable electronic device 102 in form of scrollable text to notify the user about the content of alert. The users can scroll through the information displayed on the user interface of the display screen to view the complete information. One side of the miniature portable electronic device 102 i.e. the finger ring includes an up button 500, a down button 502, a charging port 504 that can also be functions as a plurality of peripheral device interconnecting means and a plurality of pores 506 for the microphone 222 and the loudspeaker 224. In some embodiments, the miniature portable electronic device employs one of a track ball 501 and a dial control 503 for enabling the user to navigate through the display thereof. The buttons are on the side and placed in depressions or holes formed on the casing of the miniature portable electronic device 102. The touch screen display 202 displays icons and graphics of the mini-apps such as watch app, weather app, etc. installed in the miniature portable electronic device 102. The up button 500 and the down button 502 are used for speaker/microphone volume control, i.e. increasing and reducing the volume level. The charging port 504 is used for connecting a charger pin to charge the miniature portable electronic device 102, which may be carrying a rechargeable battery unit. In some instance, the charging port 504 also functions as I/O port for connecting a micro USB pin for enabling communication with the miniature portable electronic device 102 and thereby controlling the functionality of the mini-apps, adding, deleting new mini-apps etc. The backlit light means is used for providing visual alert or indications to the user. The backlit light means can produce a plurality of colors depending on the alert or indications.

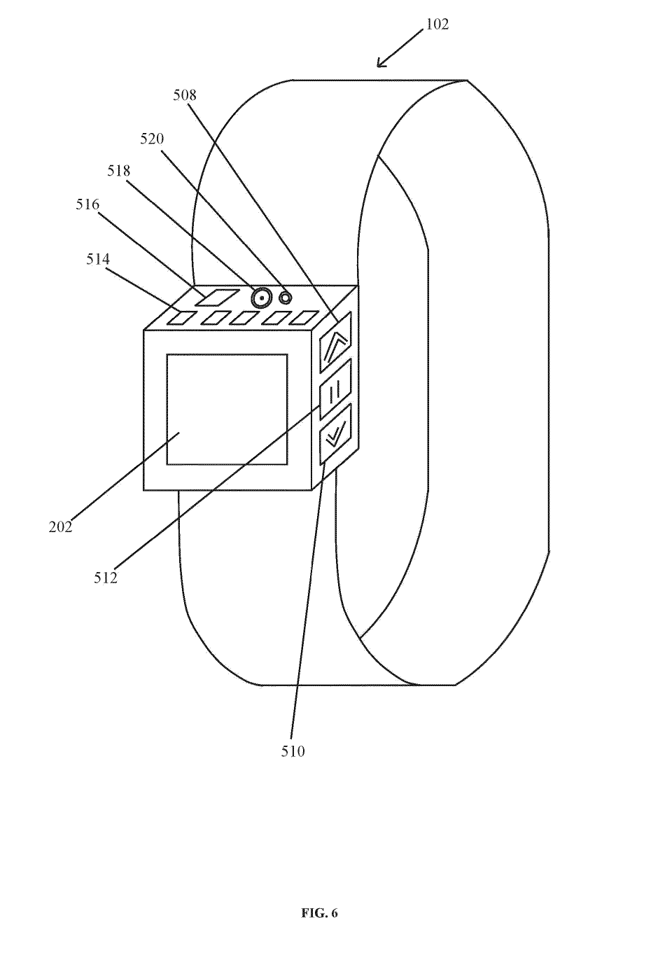

FIG. 6 illustrates a left-bottom perspective view of the miniature portable electronic device 102 that can be worn by at least one user for performing a plurality of functions according to an embodiment of the present invention. According to this embodiment, the miniature portable electronic device 102 is represented as a finger ring. One side of the miniature portable electronic device 102 i.e. the finger ring includes a previous button 508, a next button 510, a select button 512 and a plurality of top pores 514 for the microphone 222 and the loudspeaker 224. The buttons are on the side and placed in depressions or holes formed on the casing of the miniature portable electronic device 102. In some embodiments the buttons may also be touch buttons or capacitive buttons. The display screen 202 may also be a flexible touch screen. The user can scroll through the apps or different screens of the mini-app by either finger gestures on the touch screen or display 202 or hand gestures or by using the previous button 508 and the next button 510 and at least one option can be selected by using the select button 512 positioned in the middle of the previous button 508 and the next button 510. The previous button 508, the next button 510, the up button 500 and the down button 504 have arrows to indicate its functions.

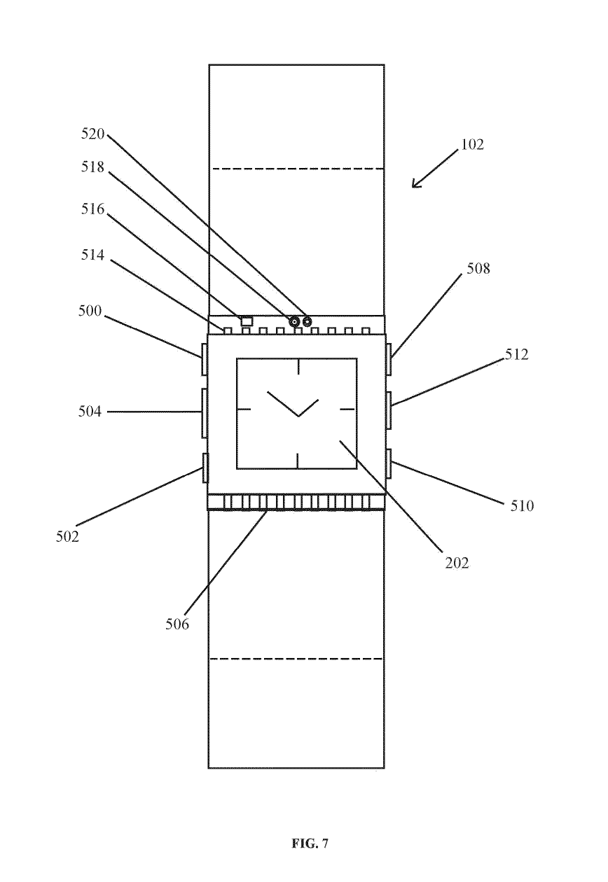

FIG. 7 illustrates a front view of the miniature portable electronic device 102 that can be worn by at least one user for performing a plurality of functions according to an embodiment of the present invention. The previous button 508, the next button 510, the up button 500, the down button 504, the select button 512 may be projecting out slightly from the casing towards the sides of the casing of the miniature portable electronic device 102. This ensures easy operation of the miniature portable electronic device 102 with the button placement positions and ease of accessing the buttons. The top ports 514 and bottom ports 506 allow the sound to escape from the loudspeaker 224 positioned inside the casing of the miniature portable electronic device 102. Also top ports 514 and/or bottom ports 506 allow the sound to receive through the microphone 222 positioned inside the casing of the miniature portable electronic device 102. Thus a plurality of sound notifications can be produced through the top holes 514 and the holes 506 at the bottom of the miniature portable electronic device 102. Similarly a plurality of visual indications can also be produced through the top holes 514 and the holes 506 at the bottom of the miniature portable electronic device 102. The microphone 222 and the loudspeaker 224 allow the user to make and receive calls using the miniature portable electronic device 102, i.e. the finger ring.

The activation of one or more buttons of the miniature portable electronic device 102 provides a plurality of features for the miniature portable electronic device 102. In some instances, the display unit or the display screen 202 of the miniature portable electronic device 102 is not a touch screen. The user can click both Up button 500 and Previous (‘Prev’) buttons 508 same time to display mini-app icons listing on miniature portable electronic device's display screen 202 at any time. The miniature portable electronic device's display screen may till then be displaying, for example, a device face, which may be obtained from device faces mini-app, watch face, which may be obtained from watch faces mini-app or music mini-app's mini-app icon that was just selected and till then the music mini-app is playing music. The system user or the user can then clicks Prev button 508 and Next buttons 510 to see one app icon at a time on the miniature portable electronic device's display screen 202. The system user can click the Select button 512 to select specific mini-app to run. If this mini-app uses same resources of miniature portable electronic device 102 e.g. speaker as the previously selected mini-app, it will stop the previously selected mini-app. Else, it will not stop the previously selected mini-app from running in background. In case of mini-apps that have additional screens instead of just mini-app icon, like weather mini-app, device faces mini-app, watch faces mini-app, etc., once the system user selects the mini-app by clicking the Select button 512, he/she clicks Prev button 508 and Next buttons 510 to move across selected mini-app's screens. While doing this the miniature portable electronic device 102 can be used to make and receive calls and pressing Up 500 and Down buttons 502 adjust the speaker/microphone volume since system user may also be talking on phone at the same time and these buttons are volume controls for the speaker/microphone. If the miniature portable electronic device's mini-app's screen has more content than what can be displayed on miniature portable electronic device's display screen 202, the system user clicks Next 510 and Prev buttons 508 to scroll the screen down and up to view the full content of mini-app's screen. Once the system user reaches the bottom of the screen by clicking Next button 510, the system user can continue to click Next button 510 one more time to go to next screen of this mini-app. Similarly, the system user continues to click Prev button 508 to reach the top of screen of mini-app from bottom and further clicks Prev button 508 one more time to go to previous screen of this mini-app. To delete a mini-app i.e. the non-system mini-app from the mini-apps list on miniature portable electronic device 102, the system user selects the mini-app icon to delete and presses and holds onto the Select button 512 for 2 seconds after which the mini-app icon dangles on the screen with a big cross mark or X-mark overlaying it. The system user now clicks the Select button 512 once again to delete the crossed mini-app from the miniature portable electronic device 102, which also immediately disables the functionality of counterpart mini-app on the miniature portable electronic device's smart device app on smart device 104 and hides the screens of counterpart mini-app on the smart device app. The system user can alternatively click the Prev button 508 or the Next button 510 instead of Select button 510 to escape (CANCEL) deleting the mini-app and go to the previous screen that was showing the uncrossed mini-app icon in steady state. The system mini-apps of miniature portable electronic device 102 cannot be deleted by the system user.

In some instances the miniature portable electronic device's display screen 202 is touch screen. The system user clicks both Up button 500 and Prev buttons 502 to display mini-app icons listing on miniature portable electronic device's display screen 202 at any time. At this time, the miniature portable electronic device's display screen 202 may till then be displaying for example a device face obtained from device faces mini-app, watch face, which is from watch faces mini-app or music mini-app's mini-app icon that was just selected and the music mini-app is playing music. The system user can scroll the display screen 202 up and down with finger, preferably using little finger i.e., pinky finger since miniature portable electronic device's display screen 202 is small, to see list of mini-app icons on miniature portable electronic device 102. The system user double-taps once the mini-app icon on screen to select specific mini-app to run. If this mini-app uses same resources of miniature portable electronic device e.g. speaker as the previously selected mini-app, it will stop the previously selected mini-app. Else, it will not stop the previously selected mini-app from running in background. In case of mini-apps that have additional screens instead of just mini-app icon, like weather mini-app, device faces mini-app, watch faces mini-app, etc., once the system user selects the mini-app by tapping once on mini-app icon in mini-app icons list, he/she swipes the finger left to right and vice-versa to see selected mini-app's screens. If the miniature portable electronic device's mini-app's screen has more content than what can be displayed on the miniature portable electronic device's display screen 202, the system user swipes his/her finger top to down and vice-versa to view the full content of mini-app's screen. The system user swipes his/her finger left to right and vice-versa to move across this mini-app's screens. To delete a mini-app, i.e., only a non-system mini-app, from the mini-apps list on miniature portable electronic device 102, the system user selects the app icon to delete and presses and holds onto the mini-app icon for 2 seconds on the miniature portable electronic device's display screen 202 after which the mini-app icon dangles on the screen with a big cross mark or X-mark overlaying it. The system user can now tap the crossed mini-app icon once to delete the mini-app from the miniature portable electronic device 102, which also immediately disables the functionality of counterpart mini-app on the miniature portable electronic device's smart device app on smart device 104 and hides the screens of counter-part mini-app on the smart device app. The system user can alternatively click the Prev button 508 or the Next button 510 instead of tapping once on the screen to escape deleting the mini-app and go to the previous screen that was showing the uncrossed mini-app icon in steady state. The system mini-apps of miniature portable electronic device 102 are preinstalled and cannot be deleted by the system user. The miniature portable electronic device's mini-apps display mostly icons, symbols, labels, few letters, few words, signs, etc., than full-length textual content due to miniature size of miniature portable electronic device's display screen 202.

The miniature portable electronic device 102 is capable of producing a plurality of alerts through the loudspeaker 224, vibration motor (haptic feedback/vibrations) or through the display or the combination of any of these. If the miniature portable electronic device's mini-app receives an alert through the smart device 104, the miniature portable electronic device 102 generates an alert to the system user by vibrating the miniature portable electronic device 102 or outputting an alert ringtone/beep from miniature portable electronic device 102 or turning on the backlit light or doing combination of any two or doing all three, as per user-defined settings for mini-app in the miniature portable electronic device's smart device app on the smart device 104. These user-defined settings also include optionally specifying particular alert ringtone/beep for the mini-app to identify the alerts of the mini-app uniquely. Also if system user has specified only vibration for alert, then he/she can choose between longer vibration, for example, 5 seconds, shorter vibration i.e. 3 seconds and quick vibration i.e. 1 second. If system user has specified combination of vibration and ringtone, the vibration will continue for the duration of the ringtone. Displaying the mini-app's info e.g. app icon or mini-app's title and optionally few characters/words of alert info that can be made visible and read by scrolling the display screen using Prev button 508 and Next buttons 510 for non-touch screen or swiping finger top-to-down for touch screen, on the miniature portable electronic device's display screen 202 during the time the alert is happening so that the system user can know which mini-app is generating the alert. The system user can dismiss the alert, which includes dismissing the alert vibration, alert sound and mini-app's info displayed on miniature portable electronic device 102 by clicking the Select button 512. The system user can optionally go to the smart device 104 and view the full alert message on smart device's display screen. E.g. the system user sets up weather alerts in weather mini-app and an extreme weather notification alert comes from this mini-app. The miniature portable electronic device 102 vibrates and shows the weather mini-app icon on miniature portable electronic device's display screen 202 which till then was showing a device face from device faces mini-app. The system user now knows that the alert is related to weather and not related to alerts from other mini-apps e.g. the social feed from social feeds mini-app, event reminder from calendar mini-app, bank overdraft notification from banking mini-app, etc., for which he/she has also set up alerts. The system user dismisses the alert i.e. vibration and mini-app's app icon display on miniature portable electronic device 102 by clicking Select button 512. She/he then goes to the smart device and sees the alert message i.e. extreme weather warning notes on the smart device 104. If the miniature portable electronic device's mini-app that renders a subset/full functionality of the smart device 104 belonging to the system user receives a communication from smart device 104, the miniature portable electronic device 102 generates an alert to the system user in same way as described above for alerts. E.g. the miniature portable electronic device's pre-loaded phone mini-app renders a subset of smart phone or smart device 104 belonging to the system 100. It allows the system user to attend phone calls coming to smartphone from the miniature portable electronic device 102 as well as make phone calls through smartphone from the miniature portable electronic device 102. The system user can end the phone call anytime by clicking Select button 512. This is equivalent to system user attending calls, making calls and ending calls from a finger ring, which is an encasement of the miniature portable electronic device 102. Advanced versions of phone mini-apps also support call holding, call merging, audio conferencing through system's smartphone and leaving voice messages. When the smart phone receives an incoming call from external source, the smartphone notifies the miniature portable electronic device 102 which in turn generates an alert to the system user by outputting a phone ringtone on miniature portable electronic device 102 and also displaying a partial phone number or partial name of caller, if the caller is present in smart phone's address book, on miniature portable electronic device's display screen 202. The system user scrolls the miniature portable electronic device's display screen 202 within the time the alert is happening to view full phone number or full name of caller and either picks the incoming call by clicking Select button 512 or rejects the incoming call by clicking Prev 508 or Next button 510 or by letting the alert to complete. In this embodiment of finger ring, the miniature portable electronic device's display screen 202 can only display maximum up to 3 lines of text of very short line width maximum up to very short-size 10 characters/line on the screen. The text displayed is crisply and legibly due to very high pixel density and very high resolution of display screen 202. The system user can see more lines by scrolling the miniature portable electronic device's display screen 202 using Prev 508 and Next buttons 510 for non-touch screen or slowly swiping finger top-to-down for touch screen. E.g. the incoming phone number is displayed on miniature portable electronic devices display screen by breaking numbers as 1-400 in line 1, 802 in line 2, 6800 in line 3 for caller phone number—14008026800. If the caller is already present in smart phone's address book, the caller info is displayed on miniature portable electronic device's display screen, by breaking words as Randolp in line 1 Wadsw in line 2 orth Lo in line 3 ngfellow in line 4— visible when scrolled, for caller's name—Randolph Wadsworth Longfellow. If the system user clicked Select button 512 and started attending the call, he now sees the miniature portable electronic device's display screen 202 change to display two text labels or two half-screen icons, if touchscreen—Microphone which is pre-highlighted and Speaker. The system user can highlight one of the two labels by using Prev 508 and Next buttons 510 and select one by clicking Select button 512. Now, the system user can increase or decrease the selected label's volume i.e. speaker volume or microphone volume of miniature portable electronic device 102 using Up 500 and Down buttons 502 while speaking to the caller, depending on where he/she is, for example, in a busy crowded market place verses office cube verses silent room. These volume settings will be preserved for future calls. Also if system user is taking a private call and does not want others to hear to caller's voice, he/she can reduce the speaker volume to minimum and keep microphone volume to maximum so that he/she can place the miniature portable electronic device near to his ear to hear the caller's voice and also speak with caller without changing the miniature portable electronic device's position from ear to mouth since the miniature portable electronic device's microphone volume is set to maximum. If the miniature portable electronic device 102 is encased as a finger ring, this is equivalent to the system user keeping his palm on cheek or near ear, depending on his speaker setting and microphone 222 setting, as he/she listens and speaks to caller. Also, instead of reducing speaker volume, the system user can use pair the miniature portable electronic device with a Bluetooth headset/earpiece so that all audio comes directly to Bluetooth headset/earpiece instead of through miniature portable electronic device's loudspeaker 224. The system user can also go to smart phone and attend the incoming call from there but the system user firstly needs to un-pair the miniature portable electronic device 102 from it as they communicate with one another through say, Bluetooth and un-pairing allows the system user to use smart phone's built-in speaker and microphone.

The third party developers of the system 100 can develop a variation of phone mini-app for the miniature portable electronic device 102 using the system's Open Software Development Kit (SDK) where instead of displaying phone numbers/names of callers for incoming calls on the miniature portable electronic device's display screen 202 as part of the alert, the third party phone mini-app functions more as an Interactive Voice Response [IVR] app similar to Google Voice app for smart phones and displays voice commands to system user upon system user picking the call stating—e.g. ‘Hello, you have an incoming call from 510 . . . . If interested, press Select button on device. Else press Prev or Next button to ignore and route the caller to your voice mail’. If the caller is in system user's smartphone's address book, the third party phone mini-app will tell the name of the caller instead of caller's phone number. To achieve this, the third party developers leverage the system APIs of smartphone to read the system user's smart phone's address book and use the Text-to-Speech [TTS] APIs such as NaturalReader, Google Translate, etc. to output the text i.e., caller phone number/caller name as audio. In addition to those above, the system user can make outgoing phone calls from miniature portable electronic device's phone mini-app. The system user selects the phone mini-app icon from list of mini-apps on the miniature portable electronic device 102. The mini-app's screen displays two text labels or two half-screen icons, if touch screen—i.e. Make Call, which is pre-highlighted, Voice Mails. The system user can highlight one of the two labels by using Prev 508 and Next buttons 510 and select one by clicking Select button 512. If the system user selected ‘Make Call’, he/she can speak to miniature portable electronic device 102 just like to a Bluetooth earpiece—e.g. “Call 14008026800” or “Call Maria Kristina” if Maria Kristina is in system's smart device's address book. The phone mini-app uses Speech-to-Text translation API e.g. Google Translate API to translate speech to text and passes the call request to counterpart mini-app which is part of miniature portable electronic device's smart phone app on smart phone. This counter-part mini-app makes the phone call using smart phones system API. If the system user has used name in the call instead of number, this counter-part mini-app will check the name in smart phone's address book using smart phone's system API. If the system user selected ‘Voice Mails’, the counter-part mini-app on smart phone makes a call to system user's phone number associated to this smartphone using smart phone's system API. For miniature portable electronic device's mini-apps that support voice alerts, the system user can optionally specify voice output to normal alerts. Normal alerts, as specified earlier have vibration and/or alert audio ringtone and/or turn on backlit light and show mini-app icon on miniature portable electronic devices display screen and optionally display few characters/words of alert info on miniature portable electronic device's display screen 202 upon scroll down during the alert. The voice alert capable mini-app does all of this and additionally reads out the full alert text to the system user from miniature portable electronic device 102 using Text-to-Speech (TTS) software. For all such voice alert capable mini-apps that are installed on miniature portable electronic device 102, the system user specifics the voice alert setting as On/Off for each of the counter-part mini-apps in the miniature portable electronic device's smart device app(s) on smart device(s) 104 in addition to specifying normal alert settings i.e., vibration On/Off, alert ringtone On/Off, backlight On/Off for each of these mini-apps. Once the voice alert is set to On′ for the miniature portable electronic devices mini-app, when the alert comes, the system user gets a vibration and/or alert ringtone and/or backlight ON and sees the mini-app icon corresponding to alert on miniature portable electronic device's display screen and also optionally sees few characters/words of alert info on miniature portable electronic device's display screen when he/she scrolls down the miniature portable electronic device's display screen 202 during the alert. When the system user clicks Select button 512 to stop this alert, the mini-app icon/alert's few characters/words info that is being displayed on the miniature portable electronic device's display screen 202 is dismissed and the full alert message is read-out from miniature portable electronic device's speaker to the system user obviating the need for the system user to reach out to the smart device 104 to view the full alert message. If the voice alert message being read out happens to be a private message and the system user does not want others to hear it, he/she can reduce the speaker volume to minimum and place the miniature portable electronic device 102 near to ear to hear the voice alert message. Note that the system's voice alerts do not read out alert messages if the system user is speaking on phone but reads out if the system user is playing music.

The system user or the user can click both Down 502 and Next buttons 510 same time to lit up backlit light on miniature portable electronic device 102. The backlight stays on for 3-4 seconds. The system user can also turn on the backlit light on miniature portable electronic device 102 by shaking the miniature portable electronic device 102. If miniature portable electronic device's display screen 202 is touch screen, the system user can also turn on the backlit light by tapping on miniature portable electronic device's display screen 202 three times. The backlit light is helpful for the system user to see the miniature portable electronic device's display screen 202 brightly in different daylight times and at night times.

The mini-app icon selected by system user on miniature portable electronic device 102 goes away in 5 seconds from miniature portable electronic device's display screen 202 and the default/system user's pre-selected device face from device faces mini-app—system mini-app or 3rd party mini-app or default/system user's pre-selected watch face from watch faces mini-app—system mini-app or 3rd party mini-app is displayed at all times on miniature portable electronic device's display screen 202. For example, System user's pre-selected Ring face obtained from ring faces mini-app is displayed always on display screen 202 of miniature portable electronic device 102 encased as a Finger ring. The selected mini-app runs in the background and this app icon show up again when user presses Prev button 508 or Select button 512 or Next button 510 on miniature portable electronic device 102. The system's Open SDK allows the developer(s) to override the all-time display of device face/watch face on miniature portable electronic device's display screen 202 and display a mini-app's screen continuously while the mini-app is running. This is helpful for developers while developing device faces mini-apps, watch faces mini-apps, recording mini-apps, music mini-apps, etc., where display of mini-app's screen on miniature portable electronic device's display screen continuously while the mini-app is running is desired. For example, Recording mini-app i.e. system mini-app or 3rd party mini-app, which overrides the display of device face/watch face on miniature portable electronic device's display screen 202 and display continuously its mini-app's screen containing 'REC label with a red solid dot prefix to denote recording on miniature portable electronic device's display screen 202 until recording is completed by system user. This way, privacy issues related to any public recording of audio or video, via smart device's camera, by this mini-app is addressed. The miniature portable electronic device safely functions from wide temperatures ranging −10 degrees to 60 degrees.

The miniature portable electronic device's Bluetooth range, i.e. if using Bluetooth as communication medium to communicate with system's smart device[s], is 10 meters-100 meters, but works great when miniature portable electronic device is within 6-10 meters from system's smart device[s]. The miniature portable electronic device 102 is waterproof up to 5 ATM, works in both fresh and saltwater. The miniature portable electronic device 102 with this level of resistance is wearable by the system user, for example say, as a finger ring miniature or portable electronic device 102 around household sinks i.e. washing dishes, while playing sports, while swimming in shallow water and while running in the rain. It should not be worn while bathing with hot water, diving, snorkeling or scuba diving. Irrespective of whether the system user's smart phone or smart device 104 of the system 100 is in vibrate mode or in ringtone mode or in silent mode, if a phone call comes to this smart phone, the miniature portable electronic device 102 will vibrate and/or output an audio ringtone based on system user's alert settings for phone mini-app so that system user can attend the call from the miniature portable electronic device 102. The miniature portable electronic device 102 for the most part frees the system user's eyes and communicates to system user through audio and vibrations. It does this in a way that number of contemporary smart devices 104 such as smart phones, smart pads, Google glasses, etc., and contemporary electronic devices such as computers, Bluetooth earpieces, etc. don't do. As a perfect example of wearable technology, the miniature portable electronic device 102 is wearable all the time e.g. as a finger ring and is less noticeable once worn and makes the system user feel absolutely normal wearing it and interacting with it in a crowd unlike Bluetooth earpiece or Google glasses which make the wearer look dorky. The miniature portable electronic device 102 can be encased in various forms or encased to fit in one or more of various forms through use of accessories 103 such as a finger ring, pendant to neck chain, keychain, ear mounted device/ear ring/ear hanging, wallet-clipped emblem/badge, shirt button cap/covering, coat stud, fancy nose ring, gadget clipped to a bangle/footwear/spectacles, pocket-gadget, table-top mini gadget in office/home, refrigerator-door pasted gadget, badge on shirt, emblem on wrist band/head band/socks/cap/hat/hair band/hair clip/pant suspenders, pendant to hangings of handbag, emblem on shirt pocket/coat pocket or on shirt sleeve/coat sleeve, emblem on pen/pen cap, emblem on tie clip, detachable emblem on waist belt buckle, etc. As shown in FIGS. 12A through 12E, 13A through 13D, and 14A through 14C, exemplary embodiments involve the device head 101 being fitted to a ring, a necklace, a bracelet, a key chain, and to a pen cap. As an example of the device head 101 that is encased to fit in one or more of various forms through use of accessories 103, the miniature portable electronic device 102 can be encased as a finger ring with a detachable plastic finger band accessory 103 as can be appreciated from FIGS. 12F and 12G. The system user can pick the correct band accessory 103 size matching his/her finger. Notably, the accessories 103 attachable to the device head 101 are available in a plurality of sizes, shapes and colors for addressing the varied preferences of the user in terms of fit, style and color. The miniature portable electronic device 102 will also directly communicate with Internet web services of system's remote web servers through using wireless communication mediums such as Wi-Fi using Embedded Wi-Fi module/2G/3G/4G/etc., to support some miniature portable electronic device's software functions. The system user can control the global settings for his/her miniature portable electronic device 102 by going to Settings mini-app i.e. system's mini-app present in the system user's first smart device's first miniature portable electronic device app. Using the Settings mini-app, the system user can easily enable/disable all notification alerts of mini-apps/system by simply clicking ON/OFF for ‘All notification alerts’ label. If the system user does not want to be disturbed, he will set this setting to ON. This is an easier option than having to go to each individual mini-app's settings and turning off the notification alerts for that mini-app. Using the Settings mini-app, the system user can easily enable/disable the backlit light of miniature portable electronic device 102 by simply clicking ON/OFF for ‘Backlit Light’ label. If disabled by system user, then the standard ways of lighting up the backlight wont′ work. That is, shaking the miniature portable electronic device or pressing both Down 502 and Next buttons 510 same time or if touch screen tapping 3 times on miniature portable electronic device's display screen 202 to lit up the backlight won't work. Using the Settings mini-app, the system user can view the miniature portable electronic device's hardware and software version information by going to ‘About’ screen in this Settings mini-app. Using the Settings mini-app, the system user can set power options for the miniature portable electronic device 102, display settings i.e. brightness/contrast/etc., on the miniature portable electronic device 102, etc.

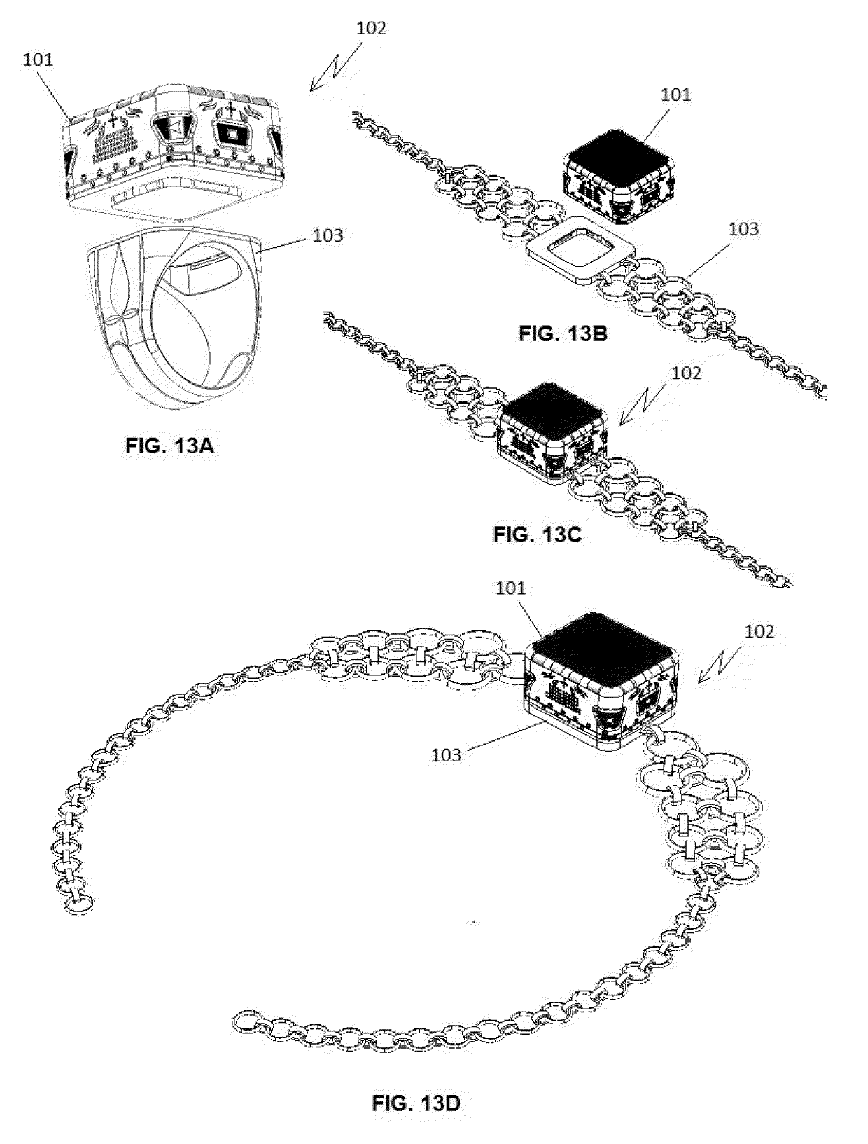

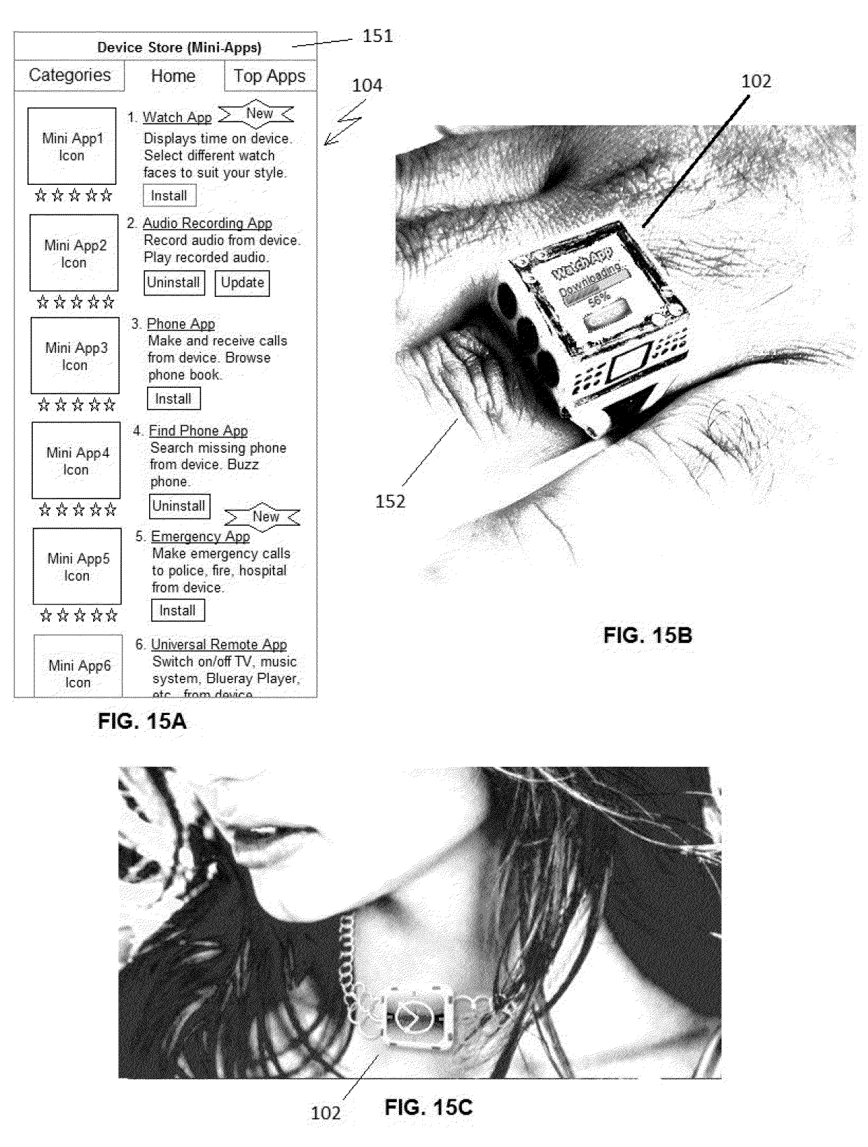

The miniature portable electronic device 102 can be a finger ring (ref. FIGS. 12A through 12E), bracelet (ref. FIG. 13C and FIG. 14C), neck pendant (FIG. 13D), key chain (FIG. 14A) and pen cap (FIG. 14 B), with the device head 101 (FIG. 13A) thereof being detachable. The detached device head 101 can be attached to another accessory 103 (ref. FIG. 13A through FIG. 13C). The buttons on ring sides can be used to operate ring screen, control appliances and contain speaker, microphone and to give voice commands, plays music, etc. The ring contains sensors to measure human activity and give metrics/recommendations. In some advanced miniature portable electronic device 102 such as the smart ring contains a camera and can stream content from Internet or uploads back to Internet. The speaker and microphone and supporting mini-app in ring allows it to make emergency calls such as in situations like when user gets a heart-attack while opening car door and his phone falls off at a distance and he/she can use ring to make 911 emergency call. In case, if the user can't find smart phone as her grand kids are playing on couch and smart phone slips underneath the couch, he/she can use ring to buzz the smart phone and find it. In some instance, if the user leaves the restaurant leaving behind the smartphone by mistake. After user walks 15 steps away from smartphone, which is placed, on restaurant table, the ring alerts the user to go and fetch the smart phone. If user wants to take group photo with colleagues in office, he/she places the smart phone having camera on a table and joins the group for photo. He/she presses the button on ring to initiate the camera on smart phone to take the picture. In some cases if the user gets phone call while driving in car and can't find the phone on car dashboard as other things are present on dashboard. So he/she clicks a button on ring to pick the phone and listen to caller at loud voice using ring speaker's full volume. She/he talks while his both hands are still rested on steering wheel to avoid driving ticket. In some instance, user cannot find a necklace having color that matches her dress as she heads for a party. She detaches the ring head 101, as shown in FIG. 13A, and wears as a pendent on her neck after setting ring head's 101 display screen color to match her outfit, as shown in FIGS. 13A and 15C. Notably, the device head 101, when attached to the necklace (FIG. 13D) or the bracelet (FIG. 13C), the miniature portable electronic device 102 is disposed centrally with respect thereto. In a more frequent case, when the user comes home from office and can't find the remote controls for TV, setup box, music systems as kids are playing in house. Then the user settles in couch and uses the ring to switch on TV, play from setup box and increase volume on music system. In some cases if user is expecting an important contract approval email from a big client and he/she is busy at a family event and can't be checking on email often. He sets up an alert for email from client prior to getting involved in family work. Gets an alert when email comes while busy setting up decoration for event. The miniature portable electronic device 102 have more number of usages and still the user can add, configure more and more new features into it.

If the system user is having difficulty with the miniature portable electronic device 102, it may be necessary for the system user to restore the miniature portable electronic device 102 to Factory settings. The system user can select ‘Factory Reset’ in the Settings mini-app of the system's mini-app present in the system user's first smart device's first miniature portable electronic device app and then follow the getting-started steps documentation for the specific smart device 104 to set up the miniature portable electronic device 102 again. The system user can press the Select button 512 and Up button 500 same time or the Select button 512 and Down button 502 same time and hold on for 3 seconds to shut down the miniature portable electronic device 102. In shutdown mode, the miniature portable electronic device 102 will still keep time. To turn the miniature portable electronic device 102 back on, the system user can again press the Select button 512 and hold on for 3 seconds. The system user should be able to use the miniature portable electronic device 102 while using standard Bluetooth headsets with the miniature portable electronic device 102. They do not interfere with the function of the each other when they are each paired with the system's smart device 104. If there is interference, the system user can easily disable the Bluetooth network on miniature portable electronic device by specifying ‘Airplane Mode’ as ON (default is OFF) in Settings mini-app (system's mini-app) present in the system user's first smart device's first miniature portable electronic device app. When the miniature portable electronic device 102 is in ‘Airplane mode’ (Bluetooth is disabled), the user will not be able to receive notification alerts and miniature portable electronic devices time will not be synced with the smart device 104. The Store mini-app (system mini-app) on the system user's smart device's miniature portable electronic device app shows the listing of free and paid mini-apps. The system user clicks on a mini-app from the mini-apps list on smart device 104. The system user sees the mini-app details screen exemplarily shown in FIG. 16D. When the system user scrolls down the details screen using his/her thumb 152, he/she sees the ‘Download and Install’ label. The system user clicks this label to download and install the mini-app. The system user sees a progress bar in place of ‘Download and Install’ label on the mini-app detail screen. The system user also sees smaller-size same progress bar on the miniature portable electronic device 102. The progress bar(s) informs the status of download/install to the system user. Once the download and install is completed successfully, the system user sees the new mini-app icon on the miniature portable electronic device 102. An exemplary depiction of the aforementioned installation process is shown in FIGS. 15A and 15B, where the user accesses the list of downloadable mini-apps through the mini-app store (device store) 151 on his/her smart device 104 (FIG. 15A). The user is shown to select an exemplary watch mini-app thereon whereafter, the same is downloaded and eventually installed on his/her miniature portable electronic device 102 as seen in FIG. 15B worn on his/her finger 152. More particularly, the selected watch mini-app is downloaded over a wireless communications network. He/she also sees a counterpart mini-app and its screens on the smart device's miniature portable electronic device app wherein, the user is enabled to configure the watch mini-app through the corresponding counterpart app such as, set the time format, select a watch face, etc. In one instance, the miniature portable electronic device 102 with a nice watch face may even be worn as a necklace as shown in FIG. 15C. The system user can now use the features/functionality of the downloaded free mini-app from the miniature portable electronic device and/or the smart device. The counterpart mini-app's files are already pre-installed on the smart device 104 as part of the miniature portable electronic device app's install on the smart device 104 or through regular app updates of the miniature portable electronic device app on the smart device 104. The clicking of ‘Download and Install’ label internally enables the mini-app's feature i.e., enables the pre-installed counter-part mini-app on the smart device 104 as well as installs the mini-app on the miniature portable electronic device 102. The installing of mini-app on the miniature portable electronic device 102 includes installing the mini-app's files like compiled code binaries, mini-app icon, other graphics, data files, etc.

The system's remote server(s) pushes new/updated apps developed by system's company or by 3rd party developers i.e. individuals/companies through the system's smart devices' miniature portable electronic device app(s) update in the smart device(s) 104. The system's company manually selects which all approved 3rd party developers' mini-apps (i.e., counter-part mini-app's files) should be included in app update after verifying these mini-apps for compliance with system's coding practices. Once the mini-app is installed/updated through system's smart device's smart device apps update performed by say, the system user, then he/she sees these mini-apps (i.e., features) in Store mini-app (system mini-app) on the smart device's miniature portable electronic device app. Whenever the Store mini-app (system mini-app) on the system user's smart device's miniature portable electronic device app is opened/run by system user, it communicates with system's remote web server[s] to check for software updates and notifies the system user if software updates for the smart device's miniature portable electronic device app are ready to install. The system user optionally updates the smart device's miniature portable electronic device app to view new/updated mini-apps in the Store mini-app of the miniature portable electronic device app. Using the Settings mini-app (system's mini-app) present in the system user's first smart device's first miniature portable electronic device app, the system user can troubleshoot miniature portable electronic device 102 issues. E.g. the system user sends ping test message (text/audio/image/vibration/backlight commands) to the miniature portable electronic device 102 using the Settings mini-app of the smart device 104. The system user will have the ability to install more than one mini-app onto the miniature portable electronic device at a time. Also, the miniature portable electronic device 102 can run more than one mini-app at a time so that user can use more than 1 mini-app at a time. The miniature portable electronic device 102 will have an application switcher built in, as well as a real-time operating program specially designed to operate the device so that core functionality such as issuing notification alerts can remain available even while a mini-app is in use. The operating program sometimes may be referred to as a tiny operating system that mimics a subset of a full-fledged operating system. To support the demands of multiple and more advanced applications on miniature portable electronic device 102, the miniature portable electronic device's powerful microcontroller (actually microprocessor) will carry lot of Flash memory (ref. FIG. 17B) and lot of RAM for performing the operations at very fast rate without any delays.

The miniature portable electronic device's mini-apps can be broken down into two broad categories such as dependent mini-apps and independent mini-apps. Dependent mini-apps are mini-apps that are fully dependent on smart device(s) 104 present in the system 100 to render functionality to the system user. They leverage the smart device's sensors, smart device's hardware/software tools (e.g. smart device's antenna [hardware], GPS utilities [software]), smart device's miniature portable electronic device app(s), etc. for its functional/data needs. Independent mini-apps are mini-apps that are not fully dependent on smart device(s) 104 present in the system 100. They can work independently offering lesser functionality when disconnected from smart device(s) 104 present in the system 100. When connected to smart device(s) 104 present in the system 100, they offer richer, complete functionality to the system user. So a miniature portable electronic device 102, say encased as a finger ring can still be used as a smart finger ring that offers limited intelligent functions. For example: The system user forgets the system's smart phone at home and gets onto a bus wearing the finger ring or the miniature portable electronic device 102. The system user can still change the ring face to a ringtone image/watch face to match his/her shirt/tie, play music (limited music) using miniature portable electronic device's loud speaker (FIG. 16E) or using Bluetooth headset, get alarm alerts, play mini-game(s), view time, record/listen to short voice memos, etc. The number of parallel mini-apps that can run on miniature portable electronic device 102 will be restricted due to limited processing power, limited RAM, limited battery power and so forth of miniature portable electronic device 102. Also, the files size of independent mini-apps that get installed on miniature portable electronic device 102 will be strictly restricted due to limited hard disk space available on miniature portable electronic device 102 so that no 3rd party mini-app developer designs the mini-app to bring lot of content on miniature portable electronic device 102 to work more elegantly as independent mini-app. The limited hard disk space of miniature portable electronic device 102 is still valid even though nowadays lot more memory is available at lesser cost and lesser physical size. This is because there could be literally hundreds/thousands of mini-apps for miniature portable electronic device 102, built by strong community of 3rd party developers of system 100, which the system user would want to download onto his/her miniature portable electronic device 102. The mini-apps that will be available for system user in the system 100 include but not limited to following. However below classification of mini-apps as dependent mini-apps and independent mini-apps is not rigid and meant for easier interpretation of concept. These mini-apps can fall into either category depending on how they are programmed and depending on what sensors are available on miniature portable electronic device 102 verses what sensors are available only on smart device 104 for mini-apps to access.

Preloaded mini-apps (system mini-apps) These mini-apps are developed by the system's company and by 3rd party developers (individuals/companies) and pre-loaded on the miniature portable electronic device 102 at the time of purchase of miniature portable electronic device 102 so that they offer base functionality of miniature portable electronic device 102 in the system 100 for the buyer or the system user. Dependent Mini-Apps include Weather mini-app on the miniature portable electronic device 102 have Screen 1—mini-app icon, Screen 2—weather digit. E.g. 20° C. or 68° F., Screen 3—weather mini image, E.g. cloud image or sun image (bright or dull) or cloud with rain image or sun with cloud image, etc., Vibrates on weather alerts (so system user sees the alert info on smart device), etc. Dependent Mini-Apps include smart device's miniature portable electronic device app(s) Informational screen(s) that display more detailed info. E.g. weather summary, Setting screen(s) to configure units (Celsius verses Fahrenheit), alerts, etc. Displays weather alerts info on smart device's display screen, etc. Calendar Events mini-app uses collaborating smart device's calendaring capabilities. This mini-app provides alerts (calendar reminders) to system user for the calendar events. Email Alerts mini-app uses collaborating smart device's email capabilities. This mini-app provides alerts for the incoming email to system user. When an incoming email arrives, the miniature portable electronic device 102 vibrates and displays this mini-app icon on miniature portable electronic device's display screen 202 for the duration of the alert. During this alerting time, the system user clicks ‘Down’ button to see sender's email address on miniature portable electronic device's display screen 202. The system user scrolls the display screen to read the full email address. If the system user is interested to read the email from this sender, he/she will go to smart device of system (e.g. smart phone) to read it where the email's partial content is displayed on smart device's display screen as a push notification. The system user can set ON/OFF for alerts to incoming email in the smart device's miniature portable electronic device app against each of his/her various email accounts which are added to this mini-app by the system user to generate email alerts for incoming emails on miniature portable electronic device 102 as well as to enable reading of the emails on the smart device's miniature portable electronic device app. The smart device's miniature portable electronic device app will communicate with either the smart device's email-related system API or directly with various 3rd party email service provider(s) through their APIs (e.g. Gmail, any IMAP email account that provides API) to bring in email alerts and email functionality to the system user for his/her various email accounts. If using an IPhone/an IPad (which runs iOS) as smart device 104, the system user must enable ‘View in Lock screen’ for each of the email accounts in the iPhone/iPad in order for iOS to forward emails onto the miniature portable electronic device 102. Phone mini-app uses collaborating smart device's phone capabilities e.g. smart phone or smart device 104. ‘Find my smart device’ mini-app, if smart phone is the smart device of the system is exemplified below. The mini-app vibrates or rings the smart phone if the system user loads this mini-app from list of mini-apps on miniature portable electronic device 102 and presses Select button 512 on miniature portable electronic device 102 so that user can find the smart phone if lost in vicinity. Internally, the software program of mini-app residing on miniature portable electronic device 102 communicates with its counterpart mini-app software program residing on smart phone using say, Bluetooth and this counterpart mini-app program on smart phone makes related smart phone's system API calls to cause the smart phone to vibrate or output a ringtone. A Voice memo mini-app i.e., Audio Recording mini-app uses collaborating smart device's audio recording capabilities. This mini-app records audio when the system user loads/runs this mini-app from list of mini-apps on miniature portable electronic device 102 and clicks Select button 512 to start recording. The system user clicks Prev 508 or Next buttons 510 to pause audio recording and clicks Select button 512 to stop audio recording which saves the audio recording to the smart device 104.

An example of independent mini-apps is a device faces mini-app. This mini-app allows the system user to select an image from its images gallery to display at all times on miniature portable electronic devices display screen 202. It comes with a set of up to 10 device faces that are pre-loaded on miniature portable electronic device 102 which the system user can readily use when miniature portable electronic device 102 is in disconnected/independent mode. Once in connected/dependent mode, the system user can select from larger number of device faces on counter-part mini-app's screen on smart device 104, i.e., on smart device app of miniature portable electronic device 102 residing on smart device 104 as well as manage (add/remove/change) the list of device faces of this mini-app on the miniature portable electronic device 102. Also, in connected/dependent mode, when the system user browses a larger list of device faces on the counterpart mini-app and selects a device face and clicks ‘download and install’ label, the requested device face image if not readily available on the smart device is requested and obtained from remote web server 108 (i.e., from system's remote web service software application) to smart device 104 and from there to miniature portable electronic device 102 where it finally resides and shows on miniature portable electronic device 102. E.g. the system user downloads a blue sapphire ring face image onto miniature portable electronic device 102 encased as a finger ring. E.g. the system user downloads a Ruby pendant face image onto miniature portable electronic device 102 encased as a pendant to neck chain. The system user can download up to 10 device faces from smart device 104 onto the miniature portable electronic device 102. And can browse these device faces (10 pre-loaded and up to 10 downloaded device faces) any time on miniature portable electronic device 102 (by selecting this mini-app on miniature portable electronic device 102) and change the device face to one that matches his/her outfit, mood, place or activity. E.g. the system user changes the ring face to blue sapphire to match the blue shirt he is wearing. E.g. the system user changes the pendant face to Ruby to match the red long dress she is wearing. The miniature portable electronic device 102 displays the selected device face (from device faces mini-app) or selected watch face (from watch faces mini-app) at all times unless overridden by another mini-app that wants to display its screen while it is running. If overridden by another mini-app and if the system user wants display selected face again, the system user stops running the mini-app and manually re-selects the face from the device faces mini-app or the watch faces mini-app. The system user can also select and install additional device faces mini-apps (free/paid) containing more device face images from the Store mini-app (system mini-app) on system's smart device 104.

The Watch mini-app (miniature portable electronic device's system mini-app) displays time on miniature portable electronic device's display screen 202 using a default watch face. Since it is a system min-app on miniature portable electronic device 102, if the miniature portable electronic device 102 is not connected to the system's smart device 104, the system user can still manually update the date and time on the miniature portable electronic device 102 using button clicks. This mini-app also includes a timer/stopwatch functionality. The system user can set the type of alert (vibration/alarm sound/etc.,) he/she should receive when the timer/stop watch stops. The Watch Faces mini-app displays several watch faces that can be applied to above watch mini-app. Watch faces are watch display designs. E.g. Circular cloak face. The system user can select one watch face from this mini-app to display on miniature portable electronic device's display screen 202 for the watch mini-app. The Music mini-app plays music from limited music files stored on miniature portable electronic device 102 if disconnected from collaborating smart device(s) 104 of the system 100. In connected mode, it will stream music from remote web server(s) 108 via system's smart device 104. This mini-app shows song name and artist name as horizontal scrolling text at the beginning of playing of the song. It also displays Prev, Play, Next music icons adjacent to 3 buttons (Prev, Select, Next buttons) of the miniature portable electronic device 102 to guide the system user to use these buttons while using this mini-app. An Alarm mini-app will trigger the backlight of miniature portable electronic device to lit up along with causing the miniature portable electronic device 102 to vibrate and/or output alarm sound, as specified by system user. The steps for setting alarm using the Alarm mini-app includes the steps of Screen 1—mini-app icon, Screen 2—View/Change Date. E.g. MM/DD/YY. The system user clicks Prev 508 and Next buttons 510 to move across month, date and year and clicks Select button to select one of 3 items. Then the system user clicks Prev 508 and Next buttons 510 to decrease and increase that item's number (e.g. month number). To not set alarm, user can select 0 for all 3 items or pick a date that is less than current date. Once the desired date is set, the system user double-clicks the Select button 512 to make the cursor come out of this screen. Now, the system user can click Prev 508 and Next buttons 510 to move across the app's screens. Screen 3—View/Change Time. E.g. HH:MM:SS. To not set alarm, user can select 0 for all 3 items. Vibrates/outputs alarm sound/displays alarm app mini-icon on alarm date and time. In some instances the mini-app will copy the 5 alarms configuration which the system user may have set on smart device's counter-part mini-app onto the miniature portable electronic device 102 when the miniature portable electronic device 102 is in connected mode (dependent mode) with the smart device 104 so that when the miniature portable electronic device 102 is in disconnected mode (independent mode), it can support these alarm alerts as well. On smart device's miniature portable electronic device app(s) up to 5 additional alarms in connected/dependent mode. Users can view alarms screen, which displays up to all 5 alarms info along with alarm notes if entered by the system user. The system user can set each of the alarm to On/Off here. ‘Add/Change/Delete Alarm’ screen—Displays a form for the system user to add/change/delete alarms. The system user can set up to 5 alarms. He/she can also set the alarm as a recurring alarm. The system user can optionally specify alarm notes when setting the alarm. The system user can click Select button 512 to stop the alarm. The system user can also snooze the alarm for 5 minutes by clicking Select button 512 quickly twice. The system user clicks Prev button 508 or Next button 510 during the time alarm alert is in progress to view the alarm notes on miniature portable electronic device 102 and decide to snooze/stop alarm. The system user continues to see the alarm notes on miniature portable electronic device for 5 seconds after alarm is stopped. After 5 seconds, the alarm note is replaced with device face/watch face. If the system user has set the alarm alert to contain only vibration instead of a combination of vibration and alert ringtone, then the Alarm vibrations will be default set to longer vibrations (5 seconds), which can be changed by system user since it is assumed that alarm alert is meant to wake the system user from sleep. On the contrast, if the vibration alert is related to a social feed (mini-app) or incoming email (mini-app), then the mini-app creator can default set the vibration to be a quick vibration (1 second), which can be changed by system user.

Game mini-app allows the system user to play a game [say, a miniature game] on the miniature portable electronic device 102 using the miniature portable electronic device's display screen and its 4 buttons. Examples: Car mini-game—This mini-app requires the system user to drive a car (denoted by a dot) on a track across the miniature portable electronic device's display screen to the finish line. The car should maneuver through obstructions and curves displayed on the display screen. The obstructions and curves displayed on display screen change as the car is being driven and the system user should reach the finish line without crashing the car into obstructions. The system user uses 4 buttons of the miniature portable electronic device 102 to control the car (dot) i.e., to move left, right, up, and down to dodge the obstructions and reach the finish line. The miniature portable electronic device's display screen 202 scrolls/rolls over during the game to create the race track feel to the system user. The system user can pause the game by pressing Select button 512. Tetris mini-game—In this mini-app, a random sequence of Tetriminos is shown as falling down from top of the miniature portable electronic devices display screen. The system user should manipulate these Tetriminos, by moving each one sideways using Up 500 and Prev 508 buttons or Down 502 and Next buttons 510. The system user can rotate the Tetrimino by 90 degree by clicking Select button 512. The system user should aim to create a horizontal line of ten blocks without gaps. Another games include Snake mini-game and Casino Slot mini-game. The miniature portable electronic device 102 comes with one or two game mini-apps pre-loaded. The system user can download more mini-games developed by system's company or by 3rd party developers to the miniature portable electronic device 102. If the miniature portable electronic device 102 encased as a finger ring is worn on finger, then the system user can use one hand's fingers to control all 4 buttons. If he/she finds difficulty playing with single hand can remove the finger ring from finger and play the game with two hands to be more efficient.

The miniature portable electronic device 102 also supports on-demand loaded mini-apps. These mini-apps are developed by either the system's company or by 3rd party developers i.e. individuals/companies using the system's Open SDK to run on the system 100. The on-demand loaded mini-apps include dependent mini-apps and independent mini-apps. The dependent mini-apps includes the following, content feeds mini-app, which provides alerts to news of interest e.g. using Google Alerts XML feed, News, websites Alerts XML feed, etc., stock alerts, Gold rate alerts, Currency alerts, etc. This mini-app displays limited info through its mini-app screen(s) to the system user on miniature portable electronic device's display screen 200. The mini-app includes News feed mini-app, Stock rates mini-app, Gold rates mini-app, Currency rates mini-app etc. In some instances, the mini-apps will provide the system user an option to listen to complete alert info using Text-to-Speech technology. An SMS mini-app, only if miniature portable electronic device 102 is collaborating with smart phone in the system 100, provides alerts to the system user as well as displays few characters of SMSs on the miniature portable electronic devices display screen 202. The system user clicks Next button 510 to see sender's info i.e., id/name/number etc. partially, and upon scrolling he/she can see full info. The system user reaches out to the smart phone i.e. system's smart device 104 to view full SMS message on smartphone and respond back to the SMS using the smart phone. Alternatively, the user may choose to respond from the miniature portable electronic device 102 itself by deploying a virtual QWERTY keypad on device head's 101 display screen 202 as shown in FIG. 16B. Notably, the keys on the QUERTY keypad are capable of being zoomed out by gestures such as pinch-zooming, double tapping, or the like. The input to miniature portable electronic device 102 can also be from external pointer such as mouse or from stylus. The SMSs can be from smart phone carrier's SMS feature or from smart phone's system message apps e.g. imessages of iPhone. Initially, the miniature portable electronic device 102 supports phone carrier's SMSs of only Android and iPhone smart devices in the system 100. Some other versions of this mini-app will also provide the system user an option to listen to complete SMS text using Text-to-Speech technology and also to respond back to the SMS message with a SMS message using Speech-to-Text technology. If system user needs privacy to listen to a private SMS, the system user can reduce speaker volume on miniature portable electronic device 102 while listening to this voice-translated SMS and keep the miniature portable electronic device 102 near to his/her ear. The Chat mini-app provides alerts to incoming chat messages from 3rd party chat providers such as Yahoo Messenger, MSN Messenger, Skype Messenger, Google Talk, AOL Messenger, etc. It uses 3rd parties' chat APIs Similar to above SMS mini-app, the system user sees partial chat message and full sender info on miniature portable electronic device and views full chat message on smart device 104 and responds back using the smart device 104 such as tablets and other touch computer. Similar to above SMS mini-app, some other versions of this mini-app will provide the system user an option to listen to complete chat text using Text-to-Speech technology and also to respond back to the chat message with a chat message using Speech-to-Text technology. Yet another Live Social feeds mini-app provides alerts to social messages. E.g. Facebook posts, Twitter feeds, Tumblr feeds, etc. As shown in FIG. 16A, an exemplary alert is displayed on the miniature portable electronic device 102 as an notification icon with a number “1”, wherein the number “1” represents the number of notifications received. Once the user responds to the same by swiping on the screen or tapping the screen, the actual notification is displayed as shown. Banking mini-app provides alerts to system user for overdraft, ATM money withdrawals above set limit, purchase transactions above set limit, check bounce, etc. It uses bank's secure APIs to access info and provide the alert. Third party Phone mini-app(s), only if miniature portable electronic device is collaborating with smart phone in the system 100, includes Skype mini-app (uses Skype's phone APIs to make phone calls), Google voice mini-app (uses Google's phone APIs to make phone calls), 911 mini-app (uses smart phone's system APIs to make call), This mini-app calls 911 (Police) if the system user loads this mini-app from list of, mini-apps on miniature portable electronic device 102 and presses Prev button 508/Select button 512/Next button 510 on miniature portable electronic device 102. Location-aware mini-apps (depend on smart device's antenna, GPS capabilities) provide exact location. Developers create location-aware mini-apps leveraging smart device's GPS functionality such as Nearby Restaurants mini-app, Nearby Movies mini-app, Next Bus leaving mini-app, Driving Directions mini-app, etc. When system user selects the specific location-aware mini-app, say nearby restaurants (or nearby movies) mini-app from list of mini-apps on miniature portable electronic device, if the system user specified, say India restaurants (or Bollywood movies) as a pre-defined query in settings of the mini-app in smart device's miniature portable electronic device app, then the miniature portable electronic device will output audio instructions using Text-to-Speech (TTS) technology to the system user based on this input query and input GPS coordinates from smart device's GPS. This is helpful to the system user every time whenever he/she loads this app onto miniature portable electronic device's display screen 202 from any location since the preloaded query will fetch the desired results (as audio output) to system user considering the GPS coordinates of the smart device 104. For Next Bus leaving mini-app, the pre-defined query can be either the bus number for the destination address (e.g. home address). For driving directions mini-app too, the pre-defined query can be home address. There are Radio mini-app, Nearby Gas mini-app, etc. When system user selects this mini-app from list of mini-apps on miniature portable electronic device 102, if the system user specified, say some radio channel number(s) as a pre-defined query in settings of the mini-app in smart device's miniature portable electronic device app, then the miniature portable electronic device 102 will stream that radio channel content from remote web server via Internet to smart device 104 which in turn sends to miniature portable electronic device via, say Bluetooth as audio output to the system user based on this pre-defined input query. The system user clicks Prev 508 and Next buttons 510 to move up and down his/her pre-defined list of channels on the miniature portable electronic device 102 and selects a radio channel to listen. This mini-app may not be helpful to the system user every time since if the system user is in different city/state, then this preloaded query may not fetch the desired output to system user. If radio mini-app is a location-aware radio mini-app, then if system user specified, say specific genres—Soft Jazz, Hard Rock etc., in settings of the mini-app in smart device's miniature portable electronic device app, then the miniature portable electronic device 102 will stream local audio content specific for the chosen genre to the system user based on this input query and input GPS coordinates from smart device's GPS. The system user clicks Prev and Next buttons to move up and down his/her pre-defined list of genres on the miniature portable electronic device 102 and selects a genre to listen to that genre local radio channel. This is helpful to the system user every time whenever he/she loads this app onto miniature portable electronic device's display screen 202 from any location since the preloaded query will fetch the desired results (as audio output) to system user. Another Reading book mini-app uses pre-defined query of system user to read out an e-book using Text-to-Speech software. The system user clicks Prev button 508 to rewind and reread the earlier line, Select button 512 to play or pause and Next button 510 to skip the current line and go to reading the next line in the e-book. The News reading mini-app, this mini-app uses a pre-defined query of system user or system user's current location to read news headlines and news abstracts. Recording mini-app uses collaborating smart device's audio and video recording capabilities. This mini-app records audio or video. The system user loads/runs this mini-app from list of mini-apps on miniature portable electronic device 102 and clicks Next button 510 to see Audio and Video as list items of list in mini-app's screen. The system user clicks Next button 510 and Prev button 508 to move down and up the list and clicks Select button 512 to start recording just audio or both audio and video. The mini-app uses the miniature portable electronic device's microphone system APIs or the smart device's microphone system APIs to record Audio and uses the smart device's camera system APIs to control camera actions and perform video recording. E.g. of Video recording: in which the system user keeps the iPhone or the smart device 104 of the system 100, having camera upright on an oversight location of the room and goes to other room. And when the party starts, she clicks the Select button 512 from her miniature portable electronic device 102 encased as a pendant to start video recording of the party remotely. Camera mini-app uses collaborating smart device's camera APIs and allows system user to take pictures from miniature portable electronic device 102 using smart device's camera. E.g. the system user keeps the Android phone having camera upright on a table and will have all his family members (including him) stand before the camera. The system user loads the Camera mini-app from list of mini-apps on miniature portable electronic device encased as a finger ring and gets into position for picture along with others and stealthy clicks Select button 512 from his finger ring. A Continuous Audio Recording mini-app is always in continuous audio recording mode and records audio unless user stops/pauses this mini-app's audio recording (using ‘Select’ button of miniature portable electronic device 102 or going to this mini-app's screen on smart device app of smart device 104) or powers down the miniature portable electronic device 102. It continuously records but keeps only last few hours of audio as set by system user subjected to max. value of 6 hours by continuously deleting the expired audio recording. It is helpful for user to go back within this set time to the smart device app carrying this mini-app and play back an audio moment or save it for future play back. It allows system user to crop the recorded audio file as needed and save for later play back. It continuously records audio irrespective of whether the system user is on phone call or the system user is playing back an audio moment from this mini-app or there is just plain silence. Example: A miniature portable electronic device encased as a finger ring will take advance of being proximate to system user′ mouth to record high-quality audio (from system user and from vicinity) while intelligently cancelling noise, disturbances, etc., thereby ensuring that the system user never again misses recording an audio moment in his/her life.

Sensor-based mini-apps depend on smart device's sensors such as Gyroscope sensor, Magnetometer sensor, Proximity sensor, etc., which are not present in miniature portable electronic device 102. 3rd party Music mini-apps, Pandora mini-app (uses Pandora API), ITunes mini-app (uses ITunes API), Google music mini-app (uses Google music API) etc. Educational/Entertainment Audio Quiz Game mini-app asks questions with 3 multi-choice answers via miniature portable electronic device's loudspeaker 224 to the system user based on system user's pre-selected topic(s) of interest in system's smart device 104. The system user can press Prev button 508 to select 1st choice, Select button 512 to select 2nd choice and Next button 510 to select 3rd choice. The mini-app vibrates if selected option is wrong answer. If correct answer is selected, it asks the next question. Many 3rd party developers can build mini-versions of their games as mini-apps for the system 100. The system user plays the game using the miniature portable electronic device's buttons and sees the game display on bigger display screen of a compatible device (i.e., which supports apps and wireless connection) such as computer [e.g. Windows 8 OS] or television [e.g. Samsung TV] or smart phone [Windows 7 phone] where the counter-part game mini-app is installed. Example: Mini-apps for Xbox games, PlayStation games, smart phone gaming apps etc., can be built by 3rd party developers [individuals/companies] using the system's Open SDK.

A 3rd party doorbell mini-app alerts the system user to the doorbell sound through miniature portable electronic device 102, which may be encased as a finger ring in noisy situations such as when carpentry work/boring work is happening in the house or when loud music from music system's speakers is playing in the house. Based on alert settings set by the system user for the doorbell mini-app, the miniature portable electronic device 102 outputs the doorbell click alert as a doorbell ringtone/vibration/turning on backlight on the miniature portable electronic device 102. If the doorbell carries a small camera, say as part of the doorbell switch and say, the doorbell switch is located at center top of the door, then the miniature portable electronic device 102 would also display the face of the person ringing the doorbell as part of the alert since the camera would take a picture when the person clicks the doorbell and sends it to the miniature portable electronic device 102 [finger ring]. And if the doorbell has a door lock component, then the system user can open the door for the person using the miniature portable electronic device 102. The mini-app communicates with Bluetooth doorbell via the doorbell company's mini-app or the 3rd party mini-app installed on the system's Bluetooth-enabled smart device 104. The Bluetooth doorbell communicates with the smart device 104 via Bluetooth and passes the doorbell click event and optionally camera image to the doorbell's mini-app developed by the doorbell's company which processes this event and passes it to counterpart mini-app on miniature portable electronic device 102 as an alert.

The Independent Mini-Apps running on the miniature portable electronic device 102 includes 3rd party Device faces mini-app, 3rd party Watch faces mini-app, 3rd party Alarm mini-app, Sensor-based mini-apps, which depends on miniature portable electronic device's sensors such as Accelerometer sensor, Ambient light sensor, motion sensor, optical sensor, contact intensity sensor, proximity sensor, gyroscope, magnetometer, etc., The 3rd party device faces mini-app uses the Ambient light sensor of miniature portable electronic device to better display the device face. e.g. Ring faces mini-app of miniature portable electronic device 102 encased as a finger ring that displays ring faces such as ruby, sapphire, emerald, etc., 3rd party Sleep Monitor mini-app uses the 3 axis Accelerometer sensor of miniature portable electronic device to record the movements of the miniature portable electronic device, user's sleep. It then sends this data to the counter-part Sleep Monitor mini-app on system's smart device 104 (say, smart phone), which in turn saves this data on Internet. The system user can later see a reporting on his/her sleep pattern (e.g. sleep graph[s]) on the counter-part Sleep Monitor app in smart device's miniature portable electronic device app. Another 3rd party Gym/Fitness Activities Monitor mini-app uses the 3 axis Accelerometer sensor of miniature portable electronic device to record the movements of the miniature portable electronic device 102 (say, encased as finger ring) during system user's every day activities and records the calories burnt by the system user. When the system user loads/runs this mini-app, it shows a progress bar on miniature portable electronic device's screen for calories burnt so far verses total calories goal set for the day. It also sends this data to the counterpart Gym/Fitness Activities Monitor mini-app on system's smart device (say, smart phone), which in turn saves this data on Internet. In this counter-part mini-app, the system user can later see a detailed reporting (e.g. daily activities pattern, weekly/monthly reports, etc.,) as well as also set Fitness metrics, fill & submit Fitness form, etc. A 3rd party ergonomic app uses the 3 axis Accelerometer sensor of miniature portable electronic device to remind the system user to relax and exercise if he/she is continuously in same posture for a long time. The mini-app displays various exercises diagrams on miniature portable electronic devices display screen for various intervals of alerts. The user can scroll the miniature portable electronic devices display screen to see detailed diagrams and text information of a particular exercise during the alert. The 3rd party Car Alarm/Remote mini-app, depends on miniature portable electronic device's direct Bluetooth connection with a Bluetooth device in vicinity. This mini-app alerts the system user on miniature portable electronic device (say, encased as a finger ring) using Bluetooth communication if the car is being stolen or car theft is attempted. The system user can also open/lock the car doors using the miniature portable electronic device [finger ring]. The mini-app communicates with Bluetooth-controlled Car Alarm/Remote system directly via the Car Alarm/Remote system company's mini-app (3rd party mini-app) installed on miniature portable electronic device 102. A 3rd party Room Heater mini-app depends on miniature portable electronic device's direct Infrared connection with an Infrared device in vicinity. This mini-app alerts the system user on miniature portable electronic device (say, encased as a finger ring) using Infrared communication if the room is heated beyond a threshold temperature say, while the system user is sleeping at night. The system user can also control the heater settings using the miniature portable electronic device 102 [finger ring]. The mini-app communicates with Infrared-controlled Room Heater directly via the Room Heater company's mini-app (3rd party mini-app) installed on miniature portable electronic device 102. Note that no counterpart mini-app is installed on system′ smart device(s) 104. Another 3rd party TV Remote mini-app (depends on miniature portable electronic device's direct Infrared connection within Infrared device in vicinity, This mini-app alerts the system user on miniature portable electronic device 102 (say, encased as a finger ring) using Infrared communication if the system user's pre-defined favorite program is currently being played on a TV channel. The system user specifies favorite programs ahead of time in the Infrared-controlled TV seeing the TV programs menu in the TV's display screen and selecting favorite programs in various channels using TV Remote. The system user can also start TV, scroll through TV channels on miniature portable electronic device's display screen and select a channel, and power-off TV using the miniature portable electronic device [finger ring]. The mini-app communicates with Infrared-controlled TV directly via the TV company's mini-app (3rd party mini-app) installed on miniature portable electronic device 102.

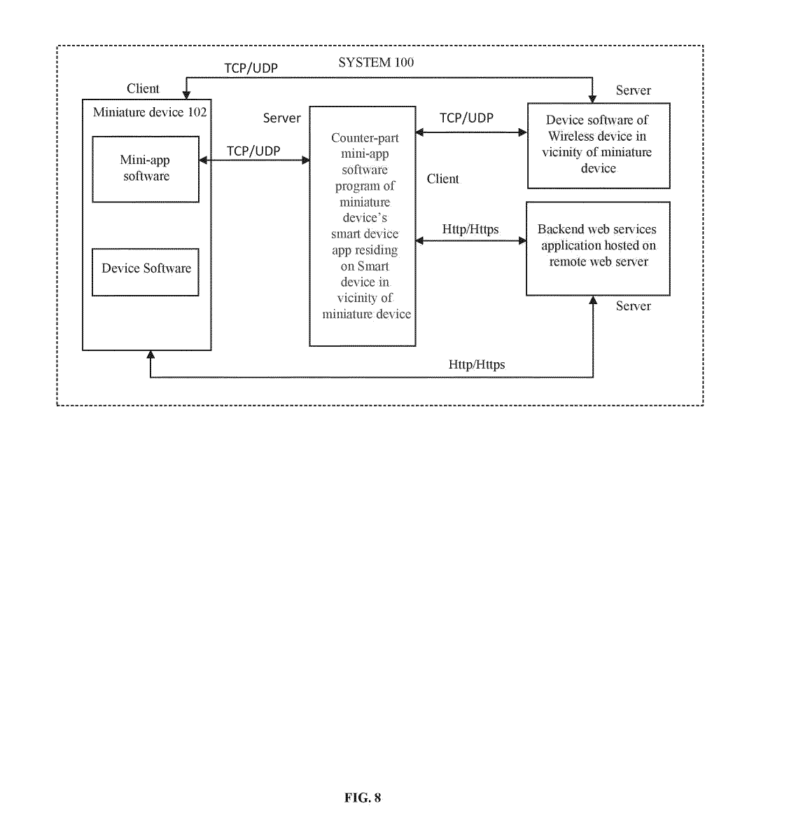

FIG. 8 illustrates a block diagram showing a high-level communication between software applications in the system according to an embodiment of the present invention. The wireless communication between the software program of mini-app residing on miniature portable electronic device 102 and its counterpart mini-app software program of miniature portable electronic device's smart device app residing on smart device 104 is based on TCP (connection-oriented)/UDP (connectionless) Internet Protocols. The client mini-app (i.e. the mini-app software program residing on miniature portable electronic device) communicates via the open socket's listening port with the server mini-app (i.e. the counter-part mini-app software program of miniature portable electronic device's 102 smart device app residing on smart device 104). The communicating mini-apps programs may or may not maintain a stateful communication, depending on underlying functional needs. Stateful session maintains state information (i.e., conversational information) between multiple request-responses of client and server whereas stateless session doesn't. The wireless communication between the counterpart mini-app software program of miniature portable electronic device's smart device app residing on smart device 104 (which acts as a client) and its backend web services application hosted on remote web server(s) 108 of the system 100 is based on http/https protocols. This communication may/may not be stateful, depending on functional needs.

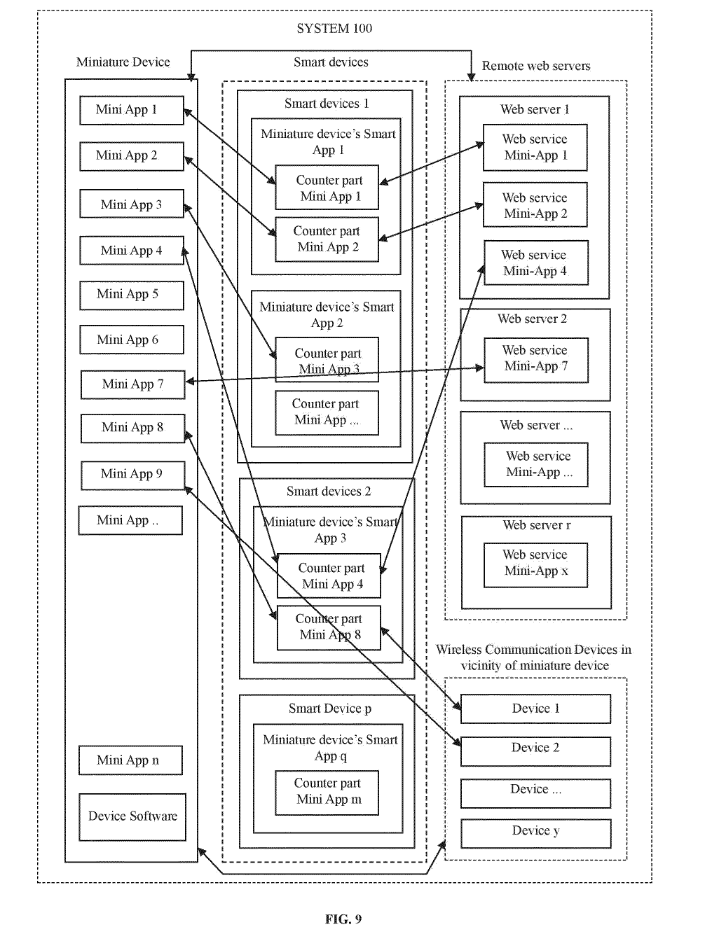

FIG. 9 illustrates a block diagram showing a detailed communication between software applications in the system having a miniature portable electronic device connected to a plurality of smart devices 104, a plurality of wireless electronic devices 106 and a plurality of remote web servers 108, according to an embodiment of the present invention. The system 100 uses miniature portable electronic device 102 having a plurality of mini-apps installed within to interact with the plurality of miniature portable electronic device's smart device application 102. The plurality of smart device is connected to a plurality of remote web servers 108 and to a plurality of wireless electronic device 106 over the wireless communication network 110. The mini-app software programs of miniature portable electronic device's smart device app residing on smart device 104 runs as a background process on smart device and listens and responds to intermittent requests from the counter-part mini-app software program residing on miniature portable electronic device (client) as well as pushes alerts (if any) onto the counterpart mini-app software program residing on miniature portable electronic device (client), as in case of Alarm mini-app, calendar events mini-app, Live Social feeds mini-app, etc. The counterpart mini-app software program residing on miniature portable electronic device (client) in turn outputs vibration or ringtone to alert the system user. For push alerts to work on miniature portable electronic device 102, the system user should firstly enable push notifications on smart device 104 for the miniature portable electronic device's smart device app(s) residing on smart device 104. For example, if smart device is iPhone, the system 100 user goes to Settings app (not mini-app) in iPhone and under Notifications section, selects the miniature portable electronic device's app from list of apps on iPhone, which brings up a new screen. In this screen, he/she selects ON for ‘Notification Center’ i.e., for receiving notifications from this app and also scroll down in same screen and select ON for ‘View in Lock Screen’ for this miniature portable electronic device's iPhone app. As long as miniature portable electronic device's smart device app(s) containing counter-part mini-apps for mini-apps listed on miniature portable electronic device 102 residing on smart device application run in background of smart device 104 (as background server process[es] that listen and respond to requests from miniature portable electronic device 102), the system user can select a dependent mini-app on miniature portable electronic device's display screen and use its specific functions.

The miniature portable electronic device 102 would support a plurality of sensors, highly Interactive Voice Response (IVR) mini-apps which obviate the system user to look at miniature portable electronic devices display screen or system's smart device[s]'s display screen[s] c) directly communicate with Internet web services of system's remote web servers 108 for all its device software needs and all its mini-apps [matured IVR mini-apps] needs (due to its higher hardware configurations in future) without requiring dependency on system's smart device[s] for its functional or display needs. The miniature portable electronic device 102 would support bendable display screen. It can then be designed as a finger ring that wraps around the finger. The miniature portable electronic device 102 in future would support gesture recognition, hologram display, etc. The miniature portable electronic device 102 would support a wide array of voice commands from system user. The miniature portable electronic device 102 would act as a collaboration hub of connected devices in its vicinity. The miniature portable electronic device 102, apart from just supporting audio recording from within the miniature portable electronic device 102 would carry a miniature camera 518 with optional flash 520 that would allow video recording from within the miniature portable electronic device 102 instead of through smart device's camera. In certain embodiments, a camera module 518 and an associated flash light means 520 positioned in the casing of the miniature portable electronic device 102 for capturing at least one video and/or image. In some other instances, in addition to the camera module 518, the miniature portable electronic device 102 includes an infrared module 516 for generating infrared signals for controlling at least one function of the wearable electronic device. The infrared module 516 may be covered using at least one glass for enabling infrared communication with the wearable electronic device for controlling it remotely from a distance. Example: Camera capture hole will be placed at top-center of miniature portable electronic device where speaker/microphone pores are present if miniature portable electronic device 102 is encased as a finger ring. If miniature portable electronic device 102 is encased as a pendant, the camera capture hole will be placed on front side above the miniature portable electronic device's display screen 202. The main user interface of the miniature portable electronic device 102 may show a menu item, show home icon using color graphics and on top right corner of the display, display the three tiny tri-color LED indicators corner each for indicating Battery Strength, Wi-Fi Signal and Bluetooth Pairing. These indicators may not be displayed in other menu items/sub-menu items/internal screens except in settings menu item's internal screens. If battery indicator reaches low level i.e., red color, display immediately on device's screen irrespective of whichever internal screen the user is currently in so that user is alerted to take action. Continue displaying this indicator on screen till its level is rolled back from low level, i.e. red color, to charging, i.e. yellow color. Incoming call may generate ringtone both in device 102 as well as smart phone so that user has option to pick from either device 102 or smart phone and attend the call. The user can also see the entire hardware list, which is currently in communication with the miniature portable electronic device 102 from a settings screen and the connected devices' outsourcing spec's to ensure no hardware item is missing and may have software functions for seeing outsourcing spec. The device can use its own camera module 518 or can operate a cellphone camera from device enables to take photos of device user from distance, as in group photos at parties. Also, by activating the device's camera from smart phone, remote user can coordinate with device person to take photos in stealth/spy mode. The camera module 518 with the microphone 222 can also be used to record audio or video functionality. The device has the ability to start audio or video recording on device from smart phone, start audio or video recording on smart phone from device, use microphone on device and record audio or video and can browse audio or video recordings list on device and listen/view a recording.

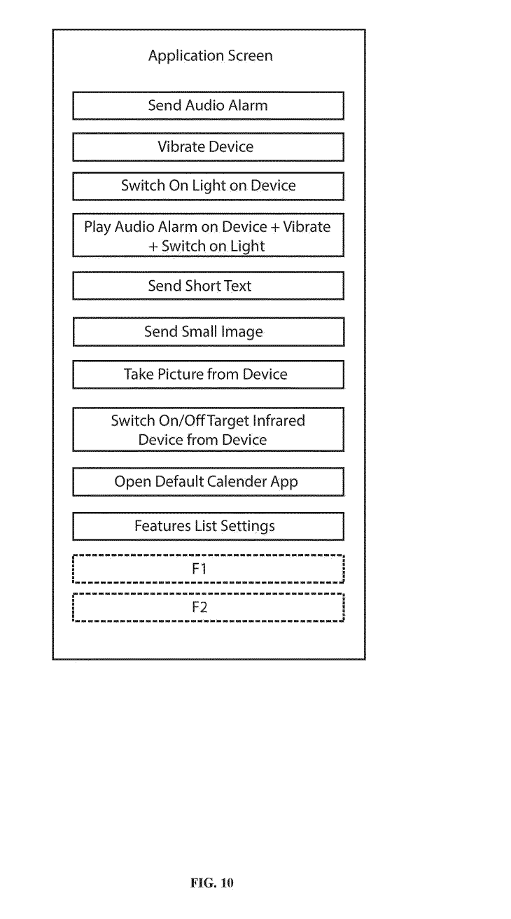

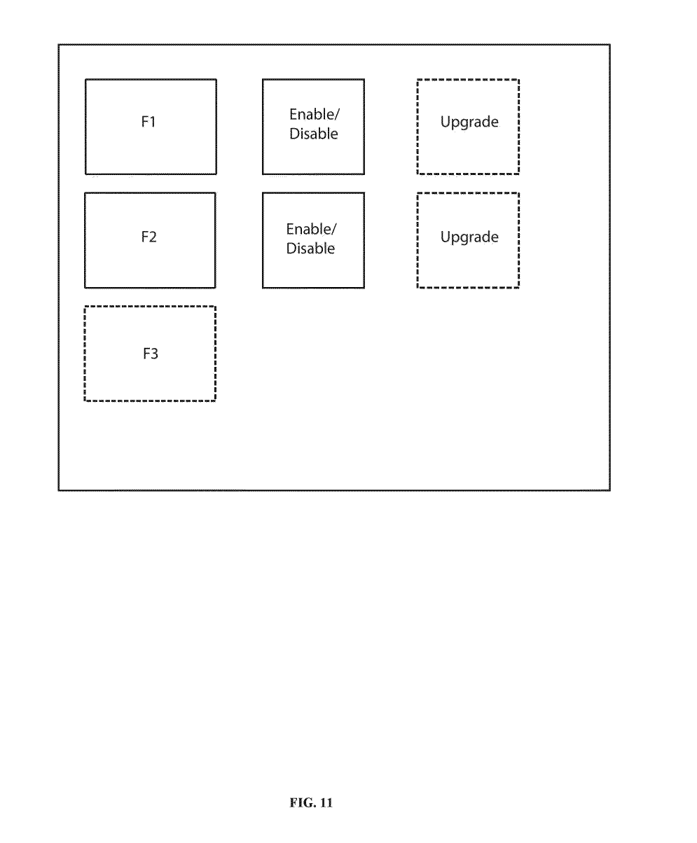

FIG. 10 illustrates a block diagram showing a miniature application screen of the miniature application running on the smart device 104 and FIG. 11 illustrates a block diagram showing a features list screen of the miniature application running on the smart device 104 according to an embodiment of the present invention. The miniature application running on the smart device 104 provides a plurality of options such as, but not limited to, option for sending audio alarm, initiate vibrate alert, switch on light on the device, play a combination of audio alarm, vibrate alert and/or switch on the backlit, option to send short texts, sending small images, take picture using camera module 518 and flash 520 on the device, record audio from the device, switch on/off the target device from the device, open default calendar app, see features list screen etc. to the user for controlling/communicating with the miniature portable electronic device 102. The features list screen in FIG. 11 allows the user to enable, disable or upgrade the smart apps or the mini-apps from the miniature application running on the smart device. The 3rd party developers can charge money from system users to buy their paid apps through Store mini-app (system mini-app) of smart device's miniature portable electronic device app where the listing of free and paid mini-apps is displayed. After purchase, the paid mini-app feature (which is already pre-installed as part of the smart device's miniature portable electronic device app) is enabled (through say, secure, encrypted passcode mechanism) on the smart device's miniature portable electronic device app as well as installed to the miniature portable electronic device so that the system user can start enjoying the features/functionality of the paid mini-app. Note that the free/paid mini-apps get pre-installed on the smart device 104 as part of the miniature portable electronic device app's install on the smart device 104 or through regular app updates of the miniature portable electronic device app on the smart device 104. Since the miniature portable electronic device's display screen 202 is very small, mini-apps on miniature portable electronic device 102 can't generate revenue through ads unlike smart device apps on smart devices (like iPhone/iPad/Android Phone/Windows Tablet/etc.,) do or as websites do. However 3rd party developers (individuals/companies) that develop miniature portable electronic device's 102 mini-apps using the system's Open SDK can still make money on their mini-apps. Offering the mini-app as free and displaying ads on the counterpart mini-app of smart device's miniature portable electronic device app. Offering limited features of mini-app for free to system users and charging money to buy their paid mini-apps which offers full features, or Offering all features of mini-app for free to system users for limited time and charging money to continue usage, or Combination of any above two or all three. The 3rd party developers (individuals/companies) may also develop miniature portable electronic device's mini-apps and offer them for free without specific monetization plan on the system to just have presence in the system and to support the customers of their products/services on the system (especially on the miniature portable electronic device).

The plurality of electronic devices of the system 100 is connected over the wireless communication network 110 for controlling some functionality or a full functionality of the wireless electronic device 106. The miniature portable electronic device 102 can be used to monitor and control a plurality of functions such as controlling the at least one wireless electronic device 106. The remote web servers 108 of the system 100 includes an instantiation of a computer-based application, which provides the network-based and other features discussed below, that may be installed and accessible. Such access may be by way of a wireless communication network 110, such as the network of networks commonly known as the Internet. In some cases, the wireless communication network 110 includes a local and/or wide area network or mobile communication network. In other instances, the communication network 106 may be a local area network (LAN) of an enterprise and/or a virtual LAN, which is instantiated over the Internet or other networks of networks. The remote web server 108 is communicatively coupled to the smart device 104 for transferring a plurality of information over the wireless communication network 110.

The remote web servers 108 includes similar hardware as in a computer system which includes the processing unit, a network communication unit, at least one memory unit, a storage unit and a plurality of I/O devices for connecting to a plurality of peripheral devices including an optional display unit. The remote web servers 108 is run by operating system software, Firmware and includes the customized software having a plurality of instructions for communicating with the miniature device application residing on the smart devices 104, which is capable of communicating with the mini-apps of the miniature portable electronic device 102. The remote web servers 108 may include a database utility for storing a plurality of information.

In one aspect, the user interface of the miniature portable electronic device 102 or a user interface of the mini-apps running on the miniature portable electronic device 102 provides improved interaction with the miniature portable electronic devices application running on the smart devices 104 such as a Smartphone or a tablet. In an embodiment, the mini-apps may have a plurality of different functions or menu options available to the user. In some embodiments, each function has a corresponding screen display layout or interface. Preferably, each menu option's respective screen display layout may occupy most or substantially the entire device display screen 202. The term “screen display layout” is used to refer to content that appears on the device display screen 202 at a given time. Some additional aspects of the present user interface include arrangements for viewing and selecting among the various different functions or menu options that may be available during execution of the given mini-apps. In an embodiment, upon selection of a function, the selected function user interface related to the plurality of options are available such making and attending phone calls from the ring, making emergency calls from ring, using a plurality of apps such as watch app, alarm app, weather app, ergonomics app, music app, sleep-monitor app, camera app, etc. then occupies most or substantially the entire device display screen 202. In this way, available display screen “real estate” is maximized for each function or feature of the running mini-app on the miniature portable electronic device 102. In some embodiments, various networking devices or external I/O devices may be utilized for interconnecting with a variety of smart device 104, wireless electronic device 106 and the remote webserver 108 through wireless/wired communication network 110. The smart device 104 may include the plurality input/output (I/O) devices e.g. button, switch, touch screen, keyboard, keypad, voice command circuit, etc. for registering commands from the user through the smart devices application. Some smart device 104 may include an alphanumeric keyboard. The keyboard may comprise, for example, a QWERTY key layout and an integrated number dial pad. A keyboard integrated into a hand-held device would typically be a thumb keyboard. The plurality of smart device 104 may also include various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, and so forth. Generally, the smart device 104 may run the software application capable of launching the smart devices application including the miniature portable electronic devices application designed to interact with the mini-apps on the miniature portable electronic device 102.

The input component or control components of the miniature portable electronic device 102 optionally include touch screen, physical buttons (e.g. push buttons, rocker buttons, toggle buttons), dial controls, slider switches, and track balls. The input could also be from biometric sensors such as heart rate monitor, pulse oximeter, pressure sensors, finger print reader, etc. The input to device could also be from coupled external devices such as keyboard, stylus, pointing device (e.g., mouse), etc.

In some embodiments, a point of contact between touch-sensitive display system and the user corresponds to a finger of the user or a stylus. The user interface of the touch-sensitive display system is designed to work with finger based contacts and gestures. Gestures consist tap, double tap, glide, trace, character or any other such input.

The wireless communication network 110 is coupled to the remote webserver 108, and the plurality of smart devices 104 and/or to the wireless electronic devices 106 and facilitates communication between components of the system 100. For example, the wireless communication net-work 110 may communicate Internet Protocol (IP) packets, frame relay frames, Asynchronous Transfer Mode (ATM) cells, or other suitable information between network addresses. The wireless communication network 110 may include one or more local area networks (LANs), metropolitan area networks (MANs), wide area networks (WANs), all or a portion of a global network such as the Internet, or any other communication system or systems at one or more locations. The smart device applications is designed to run on a variety of electronic communication devices running on a variety of operating systems including, but not limited to Android, Android SDK, iOS, Blackberry operating system, Windows phone operating system, Sailfish operating system, Firefox operating system, Tizen operating system, Ubuntu Touch operating system, macOS, Chrome, and webOS. The smart device applications is designed to be compatible with a variety of smart devices 104 including, but not limited to smartphones, tablets, laptops, ultrabooks, convertibles, smart wearable devices including Google Glass, smart watches, desktop computers, stand alone networkable devices, etc. The user can install the downloaded smart device applications in the smart devices 104 or can install manually by copying from a portable storage device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

We claim:

1. A system comprising:
a miniature portable electronic device having a plurality of hardware components capable of being operated by a plurality of instructions of a customized operating program installed in the miniature portable electronic device,
wherein the plurality of hardware components includes a microprocessor, a memory unit, a storage unit, a wireless communication module, at least one notification means, a power supply unit, a display unit, a plurality of sensors, at least one microphone, a loudspeaker, a vibrating motor and at least one of peripheral devices interconnecting means, enclosed inside a casing of the miniature portable electronic device;
a plurality of electronic devices capable of communicating with the miniature portable electronic device over a wireless communication network for providing a plurality of functionalities to the miniature portable electronic device;
at least one mini-app designed to run on the miniature portable electronic device for interacting with the plurality of hardware components of the miniature portable electronic device, the plurality of electronic devices and to the at least one user, the at least one mini-app comprises:
at least one independent mini-app, wherein a full functionality of the at least one independent mini-app is capable of being processed and rendered completely from within the miniature portable electronic device;
at least one dependent mini-app wherein a partial functionality of the at least one dependent mini-app is capable of being processed and rendered from within the miniature device;
wherein the user can perform on-demand install, upgrade and/or removal of the at least one mini-app selected by the user from at least one mini-app store,
wherein the miniature portable electronic device is capable of being installed with the at least one mini-app by connecting the miniature portable electronic device to the plurality of electronic devices,
wherein the miniature portable electronic device is capable of interacting with the plurality of electronic devices over the wireless communication network, the plurality of electronic devices comprises:
at least one smart device having internet connectivity capable of being installed with a plurality of smart device application selected from an online application store for providing a plurality of functionality to the at least one smart device,
wherein the plurality of smart device application installed in the at least one smart device is having at least one miniature device application specifically designed to run on at least one smart device for interacting with the corresponding mini-app installed on the miniature portable electronic device over the wireless communication network,
wherein some of the at least one miniature device application specifically designed to run on the at least one smart device works in synchronous with the corresponding mini-app designed to run on the miniature portable electronic device by communicating over the wireless communication network,
wherein the at least one smart device connected to the at least one miniature portable electronic device is capable of providing a plurality of on-demand functionality to the at least one miniature portable electronic device and/or the smart device including finding the miniature portable electronic device from the smart device and/or finding the smart device from the miniature portable electronic device,
at least one wireless electronic device located in the vicinity of the miniature portable electronic device,
wherein the miniature portable electronic device is connected to the at least one wireless electronic device over the wireless communication network for allowing the at least one user to communicate and control the at least one wireless electronic device using the miniature portable electronic device,
wherein the miniature portable electronic device renders a subset of functionality and/or a full functionality of the at least one wireless electronic device through at least one specific mini-app on the miniature portable electronic device specifically designed to control the at least one wireless electronic device,
wherein the at least one specific mini-app on the miniature portable electronic device is designed to control the at least one functionality and/or the full functionality of the at least one wireless electronic device remotely from within the miniature portable electronic device,
at least one remote web server capable of communicating with the miniature portable electronic device over the wireless communication network,
wherein the at least one remote web server supports at least one function of the miniature portable electronic device,
wherein the at least one remote web server supports at least one function of the at least one mini-app of the miniature portable electronic device,
wherein the at least one remote web server supports at least one function of the at least one mini-app designed to interface with the at least one wireless electronic device,
wherein the at least one remote web server supports at least one function of the at least one miniature device application specifically designed to run on the at least one smart device,
at least one data repository residing in at least one among a group of the miniature portable electronic device, at least one smart device, at least one wireless electronic device, at least one remote web server and/or at least one portable memory storage device,
wherein the miniature portable electronic device is capable of interacting with at least one software application installed in the miniature portable electronic device, the smart devices, the wireless electronic devices, the remote web servers, and/or the portable memory storage devices over the wireless communication network.

2. The system of claim 1 wherein the at least one smart device capable of being connected to the miniature portable electronic device over the wireless communication network provides a plurality of on-demand functionality to the miniature portable electronic device including addition, upgrade and deletion of the at least one miniature device application on the at least one smart device through a user interface of the at least one plurality of miniature device application, wherein the plurality of miniature device applications are selected from the online application store.

3. The system of claim 1 wherein the at least one smart device allows the at least one miniature device application running on the at least one smart device to access at least one device function of the at least one smart device needed to support at least one function of the miniature portable electronic device.

4. The system of claim 1 wherein the at least one smart device is having internet connectivity and is connected to the miniature portable electronic device over the wireless communication network for transferring a plurality of information using the at least one miniature device application specifically designed to run on the at least one smart device for communicating with the miniature portable electronic device,
wherein the at least one smart device is connected to the miniature portable electronic device over the wireless communication network for transferring a plurality of information using the at least one miniature device application working in synchronous with the corresponding mini-app on the miniature portable electronic device.

5. The system of claim 1 wherein the at least one mini-app designed to run on the miniature portable electronic device interacts with the at least one wireless electronic device located in vicinity of the miniature portable electronic device via the wireless communication network for accessing and controlling a plurality of functionality of the at least one wireless electronic device.

6. The system of claim 5 wherein the wireless communication network for accessing and controlling the plurality of functionality of the at least one wireless electronic device by the miniature portable electronic device includes Bluetooth, Infrared, near field communication (NFC), and/or via the at least one smart device.

7. The system of claim 1 wherein the at least one independent mini-app running on the miniature portable electronic device having the full functionality being processed and rendered completely from within the miniature portable electronic device by collaborating with and/or without the at least one smart device and/or the wireless electronic devices.

8. The system of claim 1 wherein the at least one dependent mini-app running on the miniature portable electronic device having the partial functionality being processed and rendered through the at least one dependent mini-app running on the miniature portable electronic device and provides a plurality of information in form of visual information, vibration, and/or audio information.

9. The system of claim 1 wherein the at least one mini-app on the miniature portable electronic device provides the plurality of information through the display unit, the display unit being a display screen for providing the plurality of information represented using icons, symbols, labels, few letters, few words, small sentences and signs.

10. The system of claim 1 wherein the display screen enables the at least one user to visualize the plurality of mini-apps installed in the miniature portable electronic device and allow the at least one user to scroll through the plurality of mini-apps installed in the miniature portable electronic device,
wherein the display screen is a touch screen display capable of interacting with the gestures of the at least one user for selecting the at least one mini-app, scrolling through the at least one mini-app, starting, stopping, deleting, upgrading the at least one mini-app running on the miniature portable electronic device,
wherein the touch screen display of the miniature portable electronic device allows the at least one user to interact with the at least one mini-app for using at least one functionality of the miniature portable electronic device.

11. The system of claim 1 wherein the at least one miniature device application running on the at least one smart device communicates with the miniature portable electronic device over the wireless communication network for performing a plurality of functions using short-range wireless communication means including Bluetooth, Infrared, near field communication (NFC),
wherein the plurality of functions performed by the at least one miniature device application running on the at least one smart device includes configuring a plurality of settings of the at least one mini-app, managing the at least one mini-app by adding and/or removing the mini-apps, extending the functionality of the at least one mini-app, leveraging at least one sensor and/or at least one function of the smart device, wherein the at least one sensor and/or the at least one function being not available in the miniature portable electronic device, providing a bigger display screen, larger processing power, larger memory, higher configuration settings, therein.

12. The system of claim 1 wherein the at least one mini-app is installed to the miniature portable electronic device by connecting the miniature portable electronic device to the plurality of electronic devices via the wireless communication network and/or the at least one peripheral device interconnecting means associated with the miniature portable electronic device,
wherein the at least one peripheral device interconnecting means includes at least one universal serial bus port (USB) and/or micro-USB port for allowing the miniature portable electronic device to be connected with the plurality of external electronic devices including a desktop computer, laptop, tablet, smartphone and smart wearable devices using a USB cable connected to the USB and/or micro-USB port for adding, updating, upgrading and removing the at least one mini-app on the miniature portable electronic device and/or for transferring data between the external electronic device and the miniature portable electronic device,
wherein the plurality of external electronic devices is an electronic device capable of communicating with the miniature portable electronic device through wired means and/or the wireless communication network,
wherein the at least one peripheral device interconnecting means including the at least one universal serial bus port (USB) and/or the micro-USB port forms a means to charge the miniature portable electronic device.

13. The system of claim 11 wherein the at least one miniature device application specifically designed to run on the at least one smart device works in synchronous with the corresponding mini-app designed to run on the miniature portable electronic device by communicating over the wireless communication network,
wherein the at least one miniature device application specifically designed to run on the at least one smart device,
wherein the plurality of smart device applications residing in the at least one smart device includes at least one miniature device application containing at least one counter-part mini-app of the at least one mini-app residing on the miniature portable electronic device.

14. The system of claim 11 wherein at least one electronic device is connected to the miniature portable electronic device through the at least one universal serial bus port (USB) and/or micro-USB port using the USB cable receives data for adding, updating, upgrading and removing the at least one mini-app on the miniature portable electronic device from the remote web server(s), Internet and/or from the portable memory storage devices and transfer data between the electronic device and the miniature portable electronic device wherein the data includes user data and system data.

15. The system of claim 11 wherein the at least one smart device application recognizes at least one mismatch between the plurality of mini-apps on the miniature portable electronic device and a corresponding counter-part miniature device application running on the at least one smart device and displays at least one message to the user on the smart device to download updated data for the miniature device application from the remote web server(s) through Internet and/or from the portable memory storage device and thereafter updating the plurality of mini-apps on the miniature portable electronic device to remove any mismatch.

16. The system of claim 1 wherein the at least one mini-app residing on the miniature portable electronic device communicates with the at least one smart device application functioning in form of the at least one counter-part mini-app of the at least one mini-app residing on the miniature portable electronic device over the wireless communication network to perform at least one function of the at least one mini-app residing on the miniature portable electronic device,
wherein the at least one mini-app residing on the miniature portable electronic device performs at least one call to at least one function of the at least one smart device for serving at least one need of the at least one mini-app residing on the miniature portable electronic device,
wherein the at least one mini-app residing on the miniature portable electronic device performs at least one call to the at least one remote web server through the internet for serving at least one need of the at least one mini-app residing on the miniature portable electronic device.

17. The system of claim 1 wherein the at least one user is capable of performing an on-demand addition, upgrade and removal of at least one mini-app to the miniature portable electronic device,
wherein the at least one user can select the at least one mini-app to add, upgrade and remove from the miniature portable electronic device from a list of mini-apps displayed on a user interface of the miniature portable electronic device's smart device application residing on the smart device,
wherein a plurality of software updates received by the smart device from the remote web server through the internet is pushed to the miniature portable electronic device's smart device application running on the smart device for adding, upgrading and removing the at least one mini-app in the miniature portable electronic device,
wherein the user can manually copy and install the plurality of software updates from the portable memory storage device,
wherein the smart device performs periodic software updates to the plurality of smart device applications including the miniature device application and the miniature portable electronic device's smart device application,
wherein a plurality of instructions for adding, upgrading and removing the at least one mini-app in the miniature portable electronic device and the plurality of data for adding and upgrading the at least one mini-app is transferred over the wireless communication network and/or wired connection using the USB cable connecting the miniature portable electronic device and the smart device and/or the miniature portable electronic device and the external electronic device including computer and laptop.

18. The system of claim 1 wherein the at least one user can select the at least one mini-app from the list of mini-apps displayed on the user interface of the miniature portable electronic device's smart device applications to add at least one mini-app's functionality to the miniature portable electronic device and the smart device application on the smart device and/or to update at least one existing mini-app's functionality on the miniature portable electronic device and the smart device application on the smart device,
wherein a process of adding at least one mini-app's functionality to the miniature portable electronic device and/or updating the at least one existing mini-app's functionality on the miniature portable electronic device is performed through transferring of a plurality of files of the at least one mini-app including compiled code files, mini-app icon, other graphics and data files from the smart device, wherein the plurality of files being received from the remote web server over the Internet,
wherein addition of the at least one mini-app's functionality to the smart device application residing on the smart device is achieved through enabling the at least one mini-app's functionality on the smart device application.

19. The system of claim 1 wherein the at least one user can remove the at least one mini-app and/or at least one functionality of the at least one mini-app selected from the list of mini-apps of the miniature portable electronic device displayed on the user interface of the miniature portable electronic device's smart device applications on the smart device,
wherein a removal of the at least one mini-app and/or at least one functionality of the at least one mini-app selected from the list of mini-apps removes the at least one functionality of the at least one mini-app on the miniature portable electronic device and the at least one mini-app's functionality on the smart device application residing in the smart device,
wherein the removal of the at least one mini-app removes plurality of files of the at least one mini-app including compiled code files, mini-app icon, other graphics and data files from the smart device and the miniature portable electronic device,
wherein removal of at least one functionality of the at least one mini-app selected from the list of mini-apps on the smart device is performed by disabling at least one functionality of the smart device application residing on the smart device.

20. The system of claim 1 wherein the miniature portable electronic device is having some functionality and/or a full functionality of the at least one smart device in communication with the miniature portable electronic device over the wireless communication network,
wherein some functionality and/or the full functionality of the at least one smart device is available to the miniature portable electronic device with and/or without the use of the at least one mini-app on the miniature portable electronic device specific to the corresponding smart device,
wherein the at least one mini-app on the miniature portable electronic device specific to the corresponding smart device communicates with the miniature portable electronic device's smart device applications residing on the smart device, wherein the miniature portable electronic device's smart device applications passes the plurality of functionality of the corresponding smart device to the miniature portable electronic device after making supported device programming calls to the corresponding smart device.

21. The system of claim 1 wherein the miniature portable electronic device is capable of being connected to the plurality of wireless electronic devices over the wireless communication network for providing at least one functionality to the miniature portable electronic device,
wherein the wireless communication network is an infrared communication for controlling the at least one functionality of the wireless electronic device,
wherein the plurality of wireless electronic devices are selected from a group comprising Bluetooth-controlled doorbell system, infrared-controlled room heater system, Bluetooth-controlled car alarm/remote system, infrared-controlled TV remote system.

22. The system of claim 1 wherein the miniature portable electronic device is having some functionality and/or a full functionality of the plurality of wireless electronic devices achieved through the at least one mini-app residing on the miniature portable electronic device and in communication with the at least one software of the plurality of wireless electronic devices,
wherein the at least one mini-app residing on the miniature portable electronic device is specific to the at least one software residing on the wireless electronic device for passing the at least one functionality and/or the full functionality of the wireless electronic device to the miniature portable electronic device, and
wherein the at least one functionality and/or the full functionality of the wireless electronic device is passed to the miniature portable electronic device after making supported device programming calls to the wireless electronic device.

23. The system of claim 1 wherein the at least one remote web server supports at least one function of the miniature portable electronic device, at least one mini-apps of the miniature portable electronic device, at least one smart device application corresponding to the at least one mini-apps of the miniature portable electronic device, and at least one wireless electronic device specific application corresponding to the at least one mini-apps of the miniature portable electronic device for interacting with the wireless electronic device.

24. The system of claim 1 wherein the miniature portable electronic device is capable of interacting with a plurality of software application for transferring data to/from the at least one data repository associated with the software application and residing in at least one among the group of the miniature portable electronic device, the at least one smart device, the at least one wireless electronic device, the at least one remote web server and/or at least one portable memory storage device.

25. The system of claim 1 wherein the user can view a list of mini-apps installed on the miniature portable electronic device using the display screen of the miniature portable electronic device and can scroll through the plurality of mini-apps installed on the miniature portable electronic device,
wherein the user can scroll through the plurality of mini-apps installed on the miniature portable electronic device by swiping on the display screen, the display screen being touch sensitive,
wherein the at least one mini-app installed on the miniature portable electronic device can be launched by selecting the at least one mini-app from a user interface of the display screen,
wherein the user can scroll through the plurality of mini-apps installed on the miniature portable electronic device by pressing at least one button on the miniature portable electronic device,
wherein the at least one mini-app installed on the miniature portable electronic device can be launched by pressing at least one button on the miniature portable electronic device.

26. The system of claim 1 wherein the miniature portable electronic device is capable of receiving at least one alert,
wherein the at least one mini-app icon responsible for the at least one alert is displayed on the display screen of the miniature portable electronic device to notify the user about a source of alert,
wherein an alert information of the at least one alert displayed on the display screen of the miniature portable electronic device is in form of scrollable text to notify the user about the content of the alert.

27. The system of claim 1 wherein the miniature portable electronic device and the plurality of components is capable of interacting with the plurality of third party developed third party software applications to extend at least one functionality of the system,
wherein the plurality of third party software applications are developed by the third party using at least one Open Software Development Kit (SDK) associated with the system,
wherein the plurality of third party software applications includes a plurality of third party mini-apps designed run on the miniature portable electronic device to extend the at least one functionality of the miniature portable electronic device,
wherein the plurality of third party mini-apps designed run on the miniature portable electronic device is capable of communicating with the at least one remote web server over the wireless communication network to provide at least one functionality to the user.

28. The system of claim 1 wherein the miniature portable electronic device contains a plurality of buttons placed on at least one side of the miniature portable electronic device,
wherein the plurality of buttons placed on the sides of the miniature portable electronic device include an up button for increasing a volume of the microphone and/or the loudspeaker and a down button for decreasing a volume of the microphone and/or the microphone, the up button and the down button being arranged on one side of the miniature portable electronic device,
wherein the plurality of buttons placed on the sides of the miniature portable electronic device include an previous button and a next button for navigating through the user interface of the miniature portable electronic device and a select button positioned in between the previous button and the next button to select at least one option from the user interface of the miniature portable electronic device,
wherein the previous button, the next button and the select button is positioned on one side of the miniature portable electronic device, and the up button and the down button is positioned on an opposite side of the miniature portable electronic device,
wherein activation of the at least one button and/or a combination of buttons by the user enables the miniature portable electronic device to perform at least one function including controlling the at least one functionality of the wireless electronic device, capturing at least one image and/or video using a camera module provided with the miniature portable electronic device.

29. The system of claim 1 wherein the miniature portable electronic device contains a charging port on one side of the miniature portable electronic device,
wherein the charging port being a micro USB port performing additional function of transferring a plurality of information from a plurality of electronic devices including at least one smart device.

30. The system of claim 1 wherein the miniature portable electronic device is built in form of a detachable, independent, center-piece gadget that can be detached from/attached to an accessory to hold the miniature portable electronic device,
wherein the accessory for holding the miniature portable electronic device includes a finger ring, neck chain's pendant, keychain, bracelet and pant belt's buckle to support multiple usages of the miniature portable electronic device for the user of the system,
wherein the plurality of accessories attachable to the miniature portable electronic device is available in a plurality of sizes, shapes and colors for addressing a plurality of preferences of the user including fit, style and color.

31. The system of claim 1 wherein the miniature portable electronic device can be used in form of an alert notification system for alerting the user to a plurality of predetermined and/or pre-set notifications set by the user for a plurality of applications running on the system.

32. The system of claim 1 wherein the miniature portable electronic device can be utilized in form of a pre-loaded query processing engine,
wherein the user is informed of a plurality of results based on a plurality of pre-determined and pre-set queries by the user for the plurality of applications running on the system,
wherein the plurality of pre-determined and pre-set queries by the user consider Global Positioning System (GPS) coordinates of the miniature portable electronic device and/or the smart device of system paired with the miniature portable electronic device to deliver location-aware results,
wherein the plurality of pre-determined and pre-set queries by the user consider data from a plurality of sensors of the miniature portable electronic device and/or the plurality of smart devices paired with the miniature portable electronic device of the system to deliver accurate results.

33. A system having a miniature portable electronic device comprising:
a microprocessor for processing a plurality of instructions and at least one mini-app designed to run on the miniature portable electronic device for interacting with a plurality of hardware components of the miniature portable electronic device, a plurality of electronic devices and to at least one user;
a memory unit for temporarily storing the plurality of instructions and the at least one mini-app and a plurality of data during execution of the at least one mini-app;
a storage unit for storing the plurality of instructions, the at least one mini-app and a plurality of data processed by the at least one mini-app and a plurality of data received from the plurality of electronic devices;
a wireless communication module for enabling communication between the at least one mini-app residing on the miniature portable electronic device and the plurality of electronic devices over a wireless communication network enabled by the wireless communication module
a plurality of sensors including an accelerometer sensor and an ambient light sensor for measuring a plurality of data, the plurality of data being associated with the at least one mini-app residing on the miniature portable electronic device;
a display unit for displaying a user interface of the at least one mini-app residing on the miniature portable electronic device and a plurality of information;
a power supply unit for powering a plurality of components of the miniature portable electronic device; and
at least one of peripheral devices interconnecting means for connecting the miniature portable electronic device with the plurality of electronic devices and for charging the power supply unit of the miniature portable electronic device;
wherein the plurality of components of the miniature portable electronic device is enclosed within a rigid casing for allowing the user to wear and/or carry the miniature portable electronic device to communicate with it and with the plurality of electronic devices over the wireless communication network.

34. The system having the miniature portable electronic device of claim 33 wherein the display unit being a display screen displays a user interface and/or at least one mini-app designed to run on the miniature portable electronic device,
wherein at least one mini-app on the miniature portable electronic device display a plurality of information on the display unit using icons, symbols, labels, few letters, few words, small sentences and signs,
wherein the display unit allows for viewing the plurality of information on the display screen of the miniature portable electronic device by scrolling the display screen up, down, left and right using at least one physical control on the miniature portable electronic device,
wherein the display unit is a touch screen display for enabling a user to provide a plurality of input in form of a plurality of touch gestures on the touch screen display,
wherein the display screen is having a pixel density and a resolution to enable the user to view the plurality of information crisply and legibly on the display screen,
wherein the display screen is a flexible touch screen display allowing to bend while in use.

35. The system having the miniature portable electronic device of claim 33 is provided with dimensions of up to 0.5 inch height, up to 0.5 inch width and up to 0.5 inch depth but may extend up to 1 inch height, up to 1 inch width and up to 0.8 inch depth depending on an planned encasement of the miniature portable electronic device.

36. The system having the miniature portable electronic device of claim 33 wherein the plurality of components is encased to fit in various form factors through use of a plurality of accessories, wherein the various forms include but not limited to a finger ring, pendant to neck chain, keychain, ear mounted device/ear ring/ear hanging, wallet-clipped emblem/badge, shirt button cap/covering, coat stud, fancy nose ring, gadget clipped to a bangle/footwear/spectacles, pocket-gadget, table-top mini gadget in office/home, refrigerator-door pasted gadget, badge on shirt, emblem on wrist band/head band/socks/cap/hat/hair band/hair clip/pant suspenders, pendant to handbag hangings, emblem on shirt pocket/coat pocket/shirt sleeve/coat sleeve, accessory on pen/pen cap, tie clip and detachable accessory on waist belt buckle.

37. The system having the miniature portable electronic device of claim 33 comprises:
at least one notification means for providing at least one notification to the user,
wherein the at least one notification means includes a backlit light means positioned inside the casing of the miniature portable electronic device for providing at least one notification to the user;
at least one microphone positioned inside the casing of the miniature portable electronic device for receiving an audio;
a camera module and an associated flash light means positioned in the casing of the miniature portable electronic device for capturing at least one video and/or image;
an infrared module for generating infrared signals for controlling at least one function of the wearable electronic device, wherein the infrared module is covered using at least one glass for enabling infrared communication with the wearable electronic device;
a loudspeaker positioned inside the casing of the miniature portable electronic device for producing an audio,
wherein the at least one microphone and the loudspeaker enables the miniature portable electronic device to make and receive a plurality of calls including at least one emergency call; and
a vibrating motor positioned inside the casing of the miniature portable electronic device for providing at least one notification to the user.
wherein the miniature portable electronic device further comprises:
a plurality of instructions installed in the miniature portable electronic device for operating the miniature portable electronic device including the plurality of hardware components,
at least one device utilities software for performing plurality of utility functions of the miniature portable electronic device having the plurality of hardware components,
at least one mini-app designed run on the miniature portable electronic device, and
at least one application switcher for switching a plurality of applications including the at least one device utilities software, at least one mini-app and the plurality of third party applications designed to run on the miniature portable electronic device.

38. The system having the miniature portable electronic device of claim 33 wherein the wireless communication module enables the miniature portable electronic device to communicate with at least one smart device, at least one wireless electronic device and at least one remoter webserver over the wireless communication network.

39. The system having the miniature portable electronic device of claim 33 wherein the at least one mini-app designed to run on the miniature portable electronic device for interacting with the plurality of hardware components of the miniature portable electronic device, the plurality of electronic devices and to the at least one user, the at least one mini-app comprises:
at least one independent mini-app, wherein a full functionality of the at least one independent mini-app is capable of being processed and rendered completely from within the miniature portable electronic device; and
at least one dependent mini-app wherein a partial functionality of the at least one independent mini-app is capable of being processed and rendered from within the miniature portable electronic device.

40. The system having the miniature portable electronic device of claim 33 wherein the user can view a list of mini-apps installed on the miniature portable electronic device using the display screen of the miniature portable electronic device and can scroll through the plurality of mini-apps installed on the miniature portable electronic device,
wherein the user can scroll through the plurality of mini-apps installed on the miniature portable electronic device by using at least one button on the miniature portable electronic device;
wherein the at least one mini-app installed on the miniature portable electronic device can be launched by pressing at least one button on the miniature portable electronic device.

41. The system having the miniature portable electronic device of claim 33 wherein the miniature portable electronic device is capable of receiving a plurality of information including at least one notification,
wherein the at least one mini-app icon responsible for the at least one alert is displayed on the display screen of the miniature portable electronic device to notify the user about the source of alert
wherein an alert information is displayed on the display screen of the miniature portable electronic device in form of scrollable text to notify the user about the content of alert.

42. The system having the miniature portable electronic device of claim 33 wherein the miniature portable electronic device is capable of being installed with the plurality of third party developed third party software applications to extend at least one functionality of the miniature portable electronic device,
wherein the plurality of third party software applications are developed by using at least one Open Software Development Kit (SDK) associated with the system,
wherein the plurality of third party software applications includes a plurality of third party mini-apps designed run on the miniature portable electronic device to extend the at least one functionality of the miniature portable electronic device,
wherein the plurality of third party mini-apps designed run on the miniature portable electronic device is capable of communicating with the at least on remote web server and to the plurality of wireless electronic devices over the wireless communication network to provide at least one functionality to the user.

43. The system having the miniature portable electronic device of claim 33 comprises a plurality of buttons placed on at least one side of the miniature portable electronic device for controlling at least one operation of the miniature portable electronic device,
wherein the plurality of buttons placed on the sides of the miniature portable electronic device include an up button for increasing a volume of the microphone and/or the loudspeaker and a down button for decreasing a volume of the microphone and/or the microphone, the up button and the down button being arranged on one side of the miniature portable electronic device,
wherein the plurality of buttons placed on the sides of the miniature portable electronic device include a previous button and a next button for navigating through the user interface of the miniature portable electronic device and a select button positioned in between the previous button and the next button to select at least one option from the user interface of the miniature portable electronic device,
wherein the previous button, the next button and the select button is positioned on one side of the miniature portable electronic device, and the up button and the down button is positioned on an opposite side of the miniature portable electronic device,
wherein the miniature portable electronic device contains a charging port on one side of the miniature portable electronic device,
wherein the charging port being a micro USB port positioned in between the up button and the down button and can perform additional function of transferring a plurality of information from a plurality of electronic devices including at least one smart device,

44. The system having the miniature portable electronic device of claim 33 comprises a plurality of holes on a top portion and a bottom portion of the casing of the miniature portable electronic device for receiving and transmitting the audio signals from the microphone and the loudspeaker,
wherein the microphone and the loudspeaker allows the user to make and receive at least one call from the miniature portable electronic device.

45. The system having the miniature portable electronic device of claim 33 wherein the plurality of buttons placed on the sides of the miniature portable electronic device allows the user to:
press the up button and the previous buttons to display mini-app icons listing on the display screen of the miniature portable electronic device at any time;
press the previous button and the next buttons to see one mini-app icon on the display screen of the miniature portable electronic device;
press the select button to select specific mini-app displayed on the display screen of the miniature portable electronic device to run on the miniature portable electronic device,
wherein a previously selected mini-app by pressing the select button of the miniature portable electronic device will run in the background when the user runs a new mini-app,
wherein a previously selected mini-app launched by pressing the select button of the miniature portable electronic device will be stopped when the user runs a new mini-app using the same resources used by the previously selected mini-app;
press the previous button and the next button from the selected mini-app screen allows the user to scroll through the plurality of information and/or features of the selected mini-app running on the miniature portable electronic device,
wherein pressing the previous button and/or the next button allows the user to scroll through the plurality of information displayed on the display screen of the miniature portable electronic device;
a long press on the select button from the mini-app select screen allows the user to delete the at least one mini-app from the miniature portable electronic device,
wherein pressing the previous button and/or the next button from a mini-app delete screen allows the user to go back to the mini-app without deleting.

46. The system having the miniature portable electronic device of claim 33 wherein an alert is produced by vibrating the miniature portable electronic device and/or outputting an alert ringtone/beep from loudspeaker of the miniature portable electronic device and/or turning on the backlit light and/or doing combination of any two and/or doing all three from within the miniature portable electronic device,
wherein the user can modify the method of producing alerts in the miniature portable electronic device by configuring from the smart device application running on the smart device.

47. The system having the miniature portable electronic device of claim 33 wherein pressing both down button and next buttons time lit up the backlit light on the miniature portable electronic device,
wherein the backlight stays on for 3-4 seconds,
wherein the user can turn on the backlit light on the miniature portable electronic device by shaking the miniature portable electronic device,
wherein the user can turn on the backlit light on the miniature portable electronic device by tapping on the display screen of the miniature portable electronic device thrice,
wherein the backlit light allows the user to see the information displayed on the display screen of the miniature portable electronic device in different daylight times and at night times.
